(19) United States
(12) Patent Application Publication
(10) Pub. No.: US 2023/0005032 A1
(43) Pub. Date: Jan. 5, 2023

(54) REAL-TIME PRICED (RTP) CELLULAR SERVICE MARKETPLACE

(71) Applicant: Aeris Communications, Inc., San Jose, CA (US)

(72) Inventors: Amit Khetawat, San Jose, CA (US); Drew S. Johnson, San Jose, CA (US); Yixiang Chen, Palo Alto, CA (US); Dae Seong Kim, Campbell, CA (US); Somasekhar Potluri, Saratoga, CA (US)

(21) Appl. No.: 17/939,249

(22) Filed: Sep. 7, 2022

Related U.S. Application Data
(63) Continuation-in-part of application No. 17/090,190, filed on Nov. 5, 2020.
Application No. 17/090,190 is a continuation of application No. 16/003,136, filed on Jun. 8, 2018, now Pat. No. 10,832,297.
Application No. 16/003,136 is a continuation of application No. 14/207,209, filed on Mar. 12, 2014, now Pat. No. 10,007,938.
(60) Provisional application No. 61/780,211, filed on Mar. 13, 2013.

(51) Int. Cl. G06Q 30/06

(52) U.S. Cl. CPC G06Q 30/0601

(57) ABSTRACT

A computer-implemented method, system and computer program product for buying and selling service for transferring a quantity of data using cellular network in a market allowing real-time pricing is disclosed. The computer-implemented method for buying and selling service for transferring a quantity of data using cellular network includes receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

### CROSS-REFERENCE TO RELATED APPLICATIONS

This application is a Continuation-In-Part of U.S. application Ser. No. 17/090,190, filed Nov. 5, 2020, which is a Continuation of U.S. application Ser. No. 16/003,136, filed Jun. 8, 2018, which is a Continuation of U.S. application Ser. No. 14/207,209, filed Mar. 12, 2014, which claims the benefit of priority to U.S. Provisional Application Ser. No. 61/780,211, filed on Mar. 13, 2013, all of which are hereby incorporated by reference in their entirety.

### FIELD OF THE INVENTION

The present invention is directed generally to cellular networks and more particularly to facilitating the purchase of data transfer service using cellular network in real time.

### BACKGROUND

Many users of devices attaching to and accessing cellular networks enter into service contracts with cellular service providers that permit use during a given time period of a specified quantity of voice minutes, messages and/or data for a set fee. Subscribers to cellular networks often are in a position where either they expect that they will not use some of the purchased capacity within the given time period, resulting in wasted money, or they will go over the permitted amounts and need to purchase excess plan capacity at high overage rates charged by cellular service providers. Accordingly, there is a need for a method and system that would allow a subscriber to either sell its excess capacity or selectively buy additional capacity on a real time basis. The method and system should be cost effective, efficient and adaptable to existing environments. The present invention addresses such a need.

### SUMMARY OF THE INVENTION

A computer-implemented method and system for buying and selling real time priced cellular service is disclosed. The computer-implemented method and system comprise storing at least one offer for a specified amount of capacity for cellular service available from a specified cellular service provider at a specified price (a capacity offer) initiated by at least one seller, and processing at least one request to discover such capacity offers (a capacity discovery request) initiated by at least one buyer for a quantity of cellular service available from a specified cellular service provider.

The processing of the capacity discovery requests further comprises matching at least one of the capacity discovery requests with one of the stored capacity offers; wherein when a match occurs the buyer is notified of the match and price and is given the opportunity to purchase the quantity of cellular service offered by the seller. The computer-implemented method and system further comprises deducting the purchased quantity of cellular service from a service profile of the seller and adding the purchased quantity of cellular service to a service profile of the buyer.

In one or more embodiments, a computer-implemented method, system and computer program product for buying and selling service to transfer a quantity of data using cellular network are disclosed.

In an embodiment, the computer-implemented method for buying and selling service for transferring a quantity of data using cellular network includes receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the system for buying and selling service for transferring a quantity of data using cellular network, having at least one server comprising a processor, and a memory in communication with the processor wherein the memory including program instructions which when executed by the processor, perform the following operations including receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the computer program product stored on a computer readable medium for buying and selling service for transferring a quantity of data using cellular network, having computer readable programming for causing a computer to control an execution of an application for buying and selling service for transferring a quantity of data using cellular network, including the steps of: receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the one or more offers for transferring a quantity of data using cellular service comprise an offer to sell the service of transferring a quantity of data using cellular service initiated by a seller or an offer to buy the service of transferring a quantity of data using cellular service initiated by a buyer.

In an embodiment, the method, system and computer program product for buying and selling service to transfer a quantity of data using cellular network includes transferring the data to be transferred by the buyer to the seller of the data quantity transfer via exchange, where the timing and process of actual data transfer is controlled by the seller of the service to transfer a quantity of data, and where the transfer of data may take place in multiple segments and may involve multiple sellers of data quantity transfer. The multiple sellers may include sellers based on geographical location as well as data transfer capacity of each seller etc.

In another embodiment, the method, system and computer program product for buying and selling service to transfer a quantity of data using cellular network includes transferring the data to be transferred by the buyer to the one or more sellers of the data transfer capacity via exchange, where the timing and process of actual data transfer is controlled by the seller of the cellular service for transferring a quantity of data, and where the transfer of data may take place in a single shot and involve one or more sellers.

In yet another embodiment, the method, system and computer program product for buying and selling service to transfer a quantity of data includes transferring the data to be transferred by the buyer to the seller, and where the timing and process of actual data transfer is controlled by the seller of the service to transfer a quantity of data, and where the transfer of data may take place in a single shot and involve single seller.

### BRIEF DESCRIPTION OF THE DRAWINGS

FIG. 1 is a flow diagram illustrating an example of a capacity offering and a capacity discovery request for the real-time priced cellular service using an exchange.

FIG. 2a illustrates creation of a capacity offer in the home location register of a cellular service provider according to an embodiment of the present invention.

FIG. 2b illustrates creation of an offer including location in addition to time, according to another embodiment of the invention.

FIG. 3 is a flow diagram illustrating a method of processing capacity discovery requests and capacity offers.

FIG. 4a illustrates the process of matching and publishing of an offer in response to a capacity discovery request initiated by a buyer according to an embodiment of the invention.

FIG. 4b illustrates the process of matching and publishing of an offer in response to a capacity discovery request initiated by a buyer including location along with price and duration of service, according to another embodiment of the invention.

FIG. 4c illustrates the process of matching and publishing of an offer in response to a capacity discovery request initiated by a buyer including quality of service (QoS) in addition to time and location, according to yet another embodiment of the invention.

FIG. 5a illustrates the processing of offers to purchase and sale of service valid during specified time period in the home location register of the cellular service provider.

FIG. 5b illustrates the processing of offers to sell and buy service valid during specified time period along with location in the HLR.

FIG. 6a illustrates a method for the exchange to process a change to a capacity offer according to an embodiment of the invention.

FIG. 6b illustrates a method for the exchange to process a change to a capacity offer according to another embodiment of the invention.

FIG. 7 illustrates the creation of price history report at the request of either the seller or the buyer.

FIGS. 8a, 8b, 8c, 8d and 8e illustrate flow diagrams illustrating exemplary offers to transfer a quantity of data using cellular network and discovery request to purchase a service to transfer a quantity of data using cellular network using an exchange, according to one or more embodiments of the present invention.

FIGS. 9a, 9b, 9c, 9d and 9e illustrate flow diagrams illustrating exemplary offers to transfer a quantity of data using cellular network and discovery request to purchase a service to transfer a quantity of data using cellular network using an exchange, according to one or more embodiments of the present invention.

FIG. 10a illustrates creation of an exemplary offer to transfer a quantity of data using cellular network in an exchange according to one or more embodiments of the present invention.

FIG. 10b illustrates creation of an exemplary offer to transfer a quantity of data using cellular network in an exchange, according to one or more embodiments of the invention.

FIG. 11 is a flow diagram illustrating a method of processing discovery requests to transfer a quantity of data using cellular network according to one or more embodiments of the present invention.

FIG. 12a illustrates the process of matching and publishing an offer to transfer a quantity of data using cellular network in response to a discovery request to transfer a quantity of data using cellular network initiated by a buyer according to one or more embodiments of the invention.

FIG. 12b illustrates the process of matching and publishing of an offer in response to a discovery request to transfer a quantity of data using cellular network initiated by a buyer including location along with price and duration of service, according to one or more embodiments of the invention.

FIG. 12c illustrates the process of matching and publishing of an offer in response to a discovery request to transfer a quantity of data using cellular network initiated by a buyer including quality of service (QoS) in addition to time and location, according to one or more embodiments of the invention.

FIG. 13a illustrates the processing of offers to purchase and sale of service to transfer a quantity of data using cellular network valid during specified time period in the local register, for example, HLR of the cellular service provider, according to one or more embodiments of the invention.

FIG. 13b illustrates the processing of offers to sell and buy service to transfer a quantity of data using cellular network valid during specified time period along with location in the in the local register, for example, HLR, according to one or more embodiments of the invention.

FIG. 14a illustrates a method for the exchange to process a change to an offer to transfer a quantity of data using cellular network, according to one or more embodiments of the invention.

FIG. 14b illustrates a method for the exchange to process a change to a offer to transfer a quantity of data using cellular network, according to one or more embodiments of the invention.

FIG. 15 illustrates the creation of price history report at the request of either the seller or the buyer, according to one or more embodiments of the invention.

FIGS. 16a, 16b and 16c illustrate system overview 1600, 1600′ and 1600″ showing offers initiated by a seller, a buyer or by both a seller and a buyer respectively according to one or more embodiments of the invention.

FIG. 17 illustrates a data processing system 1700 suitable for storing the computer program product and/or executing program code in accordance with one or more embodiments of the invention.

### DETAILED DESCRIPTION

The present invention is directed generally to cellular networks and more particularly to facilitating the purchase of data transfer service using cellular network in real time. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Given the proliferation of devices using cellular services, in the consumer, M2M and other markets, and the loss of resources both by users who spend money for unused capacity and by users who must pay for overage at high rates, it would be advantageous to provide a system and method for enabling the transfer of excess capacity. A system and method in accordance with the present invention utilize an exchange market operated by cellular service providers or other authorized parties (an exchange) that allows subscribers who have excess plan voice minutes, messages and bytes of data etc. to sell such excess to the subscribers who need them without either having to change their service contracts with their cellular service providers. An exchange is defined as a system that allows subscribers to buy and sell cellular service. The system, for example, can be operated by a cellular service provider or other authorized party. The subscribers, for example, can be any of network service providers, enterprises and consumers.

In one or more embodiments, a computer-implemented method and system are disclosed. The computer-implemented method and system allow subscribers whose contracts with a cellular service provider permit use of a specified quantity of voice minutes, messages and/or data for a set fee to use an exchange to sell excess plan voice minutes, messages, bytes of data, etc., giving rise to real-time priced cellular service for cellular subscribers, without any change to the subscribers' contracts and price plans with their cellular service providers. The computer-implemented method and system describe a network control scheme to support a real-time market for service offered at then-current real-time prices.

In an embodiment, a buyer and a seller with active subscriptions and cellular service profiles from the same cellular service provider are eligible for selling and purchasing the excess plan voice minutes, messages, bytes of data, etc. offered by the seller. The seller's subscription and service profile may be identified by an international mobile subscriber identifier (IMSI) or mobile identification number (MIN). Using the method enabled, the seller submits an offer to the exchange for sale at a given price of a quantity of excess voice minutes, short messages (SMS) or data valid for use within a specified time period. In one or more embodiments, the specified time period during which the cellular service offered is valid for use can be in multiples of one hour.

As part of an offer process, the seller also specifies cellular service profile identifiers associated with the offer. The exchange then publishes all offers in a continuous 24 hour window. A buyer enters the market through submitting a request specifying the quantity of voice minutes, messages and/or data required and a price range for this service that the buyer is willing to pay. As part of a request process, the buyer also specifies its service provider identifiers for the service profile that would use the purchased capacity. The computer-implemented method and system enables the exchange to find the lowest-priced offer that matches the buyer's requirements.

Once a matching offer is found, the exchange uses the computer-implemented method and system to complete the transaction and store any desired information, which may include the parties' respective service provider identifiers, quantity of service purchased, price and so on. In a method and system in accordance with an embodiment, the exchange then adjusts the service profiles of both the seller (deducting the quantity of service sold from available amounts) and the buyer (adding the purchased capacity to the available amounts). Accordingly, in an embodiment, an offer is allowed either to be taken off the market if quantities in the offer have been matched with at least one buyer or adjusted so that purchased amounts are removed. At the end of the purchased service period, the exchange removes the unused portion of the purchased service quantity from the buyer's service profile, without any further change to the seller's service profile. Payment settlement between the seller and buyer can be performed via a mechanism chosen and implemented by the exchange.

Additionally or alternatively, many users of devices attaching to and accessing cellular networks enter into service contracts with cellular service providers that permit use during a given time period of a specified quantity of messages and/or data for a set fee, for example, rate plans. Users with a need to transfer certain quantity of data but have the flexibility regarding time of data transfer and/or process of data transfer, may still have to purchase additional cellular service capacity from a service provider. These subscribers may face two challenges—1) They may not be able to utilize the entire purchased capacity, resulting in underutilized capacity and overspending; 2) Potential data transfer to the destination device when there is no native cellular coverage but utilizing a roaming partner cellular coverage at the device location, resulting in expensive roaming charges.

Accordingly, there is a need for a method and system that would allow a subscriber with excess capacity provide services such as data transfer on a real time basis and perform the data transfer in a cost effective, and efficient way. The present invention addresses such a need.

In one or more embodiments, a computer-implemented method, system and computer program product for buying and selling service to transfer a quantity of data using cellular network are disclosed.

In an embodiment, the computer-implemented method for buying and selling service for transferring a quantity of data using cellular network includes receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the system for buying and selling service for transferring a quantity of data using cellular network, having at least one server comprising a processor, and a memory in communication with the processor wherein the memory including program instructions which when executed by the processor, perform the following operations including receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the computer program product stored on a computer readable medium for buying and selling service for transferring a quantity of data using cellular network, having computer readable programming for causing a computer to control an execution of an application for buying and selling service for transferring a quantity of data using cellular network, including the steps of: receiving and storing one or more offers to transfer a quantity of data using cellular service; receiving and processing one or more discovery requests to transfer a quantity of data using cellular service; matching at least one of the one or more discovery requests with at least one of the one or more stored offers; and facilitating buying and selling of the service to transfer a quantity of data.

In an embodiment, the one or more offers for transferring a quantity of data using cellular service comprise an offer to sell the service of transferring a quantity of data using cellular service initiated by a seller or an offer to buy the service of transferring a quantity of data using cellular service initiated by a buyer.

In an embodiment, the method, system and computer program product for buying and selling service to transfer a quantity of data using cellular network includes transferring the data to be transferred by the buyer to the seller of the data quantity transfer via exchange, where the timing and process of actual data transfer is controlled by the seller of the service to transfer a quantity of data, and may involve multiple sellers of service for a data quantity transfer, where the transfer of data to each of the one or more sellers may take place in multiple segments. The multiple sellers may include sellers based on geographical location as well as data transfer capacity of each seller etc.

In another embodiment, the method, system and computer program product for buying and selling service to transfer a quantity of data using cellular network includes transferring the data to be transferred by the buyer to the one or more sellers of the data transfer capacity via exchange, where the timing and process of actual data transfer is controlled by the seller of the service for transferring a quantity of data, and may involve one or more sellers of service for a data quantity transfer, where the transfer of data to each of the one or more sellers may take place in multiple segments.

In yet another embodiment, the method, system and computer program product for buying and selling service to transfer a quantity of data includes transferring the data to be transferred by the buyer to the seller, and where the timing and process of actual data transfer is controlled by the seller of the service to transfer a quantity of data, and may involve single seller, where the transfer of data to the seller may take place in a single shot.

In yet another embodiment, the method, system and computer program product for buying and selling service to transfer a quantity of data includes transferring the data to be transferred by the buyer to the seller, and where the timing and process of actual data transfer is controlled by the seller of the service to transfer a quantity of data, and may involve single seller, where the transfer of data to the seller may take place in multiple segments.

In yet another embodiment, the method, system and computer program product for buying and selling service to transfer a quantity of data using cellular network includes transferring the data to be transferred by the buyer to the one or more sellers of the data transfer capacity via exchange, where the timing is controlled by the seller of the service but the process of actual data transfer is controlled by the buyer, for transferring a quantity of data, and may involve one or more sellers of service for a data quantity transfer, where the transfer of data to each of the one or more sellers may take place in a single shot.

The SIM card on the receiving device has to be configured to receive data from the cellular service profile of the particular seller of the data transfer capacity. For example, if the SIM is configured to receive data using a cellular service provider, and if the seller will use a different cellular service provider, the SIM has to be configured to receive data using the cellular service provider of the seller.

If necessary, the SIM on the receiving device needs to be reconfigured to receive data over the cellular service of the seller. And reconfigure the device back to the original cellular network used by the buyer. The exchange will provide this service, based on the cellular service used by the buyer and by the one or more sellers used for the transfer of data. This reconfiguration can be performed by the exchange, buyer or seller as appropriate.

In an embodiment, buying and selling service to transfer a quantity of data includes may also include allowing real-time pricing.

To describe the features of a system and method in accordance with the present invention in more detail, refer now to the following description in conjunction with the accompanying figures.

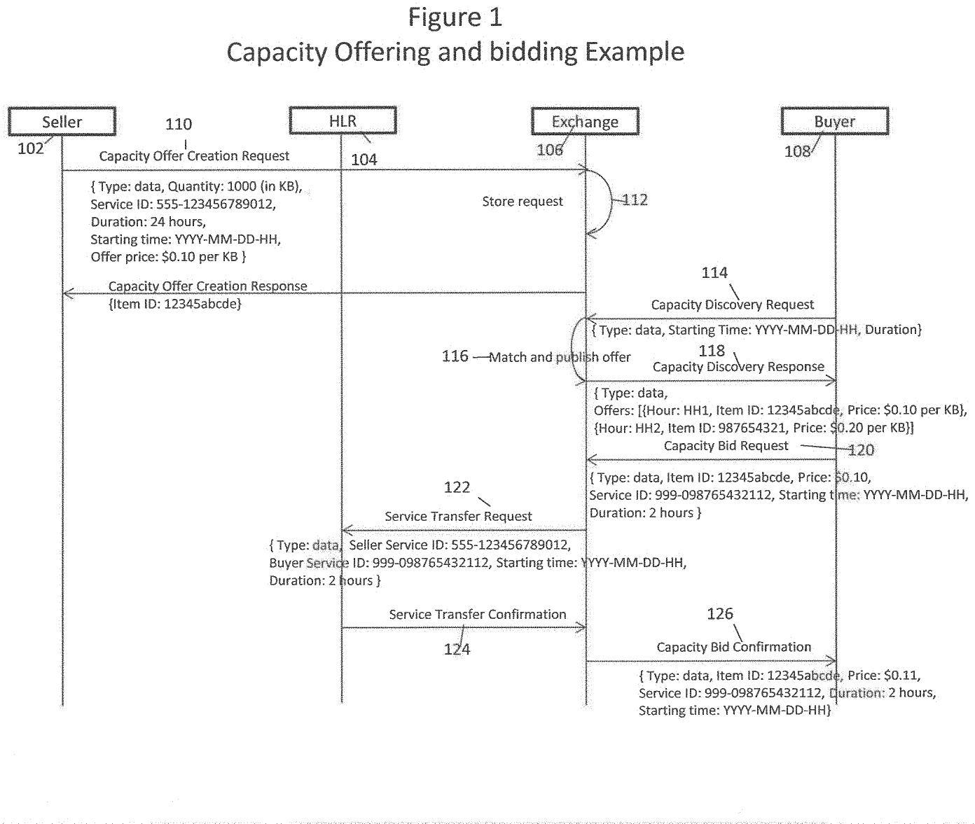

FIG. 1 is a flow diagram illustrating an example of a capacity offering and a capacity discovery request for the real-time priced cellular service using an exchange. First, a seller 102 initiates submission of an offer to a home location register (HLR) 106 of cellular service provider specifying a quantity of excess voice minutes, messages or data to be available for use for a fixed duration at a given price via step 110. In an embodiment, the period during which the offered cellular service is valid for use can be in multiples of one hour. The seller 102 may also specify cellular service profile identifiers associated with the offer. In addition, in an embodiment the seller 102 is allowed to change the offer after it is submitted. Exchange 106, which can be an exchange stores the request via step 112 and publishes all offers over a specified time period, for example, 24 hours, via step 116.

A buyer 108 initiates a capacity discovery request, for example, for any of quantity of voice minutes, messages and data required and the maximum price the buyer 108 is willing to pay, via step 114. The buyer 108 also specifies its service profile identifiers for the service profile that would use the purchased capacity. In an embodiment, the lowest priced offer that matches the requirements of the buyer 108 is determined. If a matching offer is determined, exchange 106 notifies the buyer 108 of the matching offer by sending a capacity discovery response to the buyer 108, via step 118. The buyer 108 accepts the offer by sending a capacity bid request, via step 120 to the exchange 106, which then sends a service transfer request, via step 122 to HLR 104. The HLR 104 then sends a service transfer confirmation, via step 124 to the exchange 106 which in turn sends a capacity purchase confirmation to the buyer 108, via step 126. The offer is taken off the market after expiration of the offer or sooner if quantities in the offer have been matched with at least one buyer 108.

In an embodiment, the purchased service quantity will be deducted from the service profile of the seller 102, and that the purchased service quantity will be added to the service profile of the buyer 108. The purchased service quantity is associated with duration of time for which it is available for use. At the end of the duration of the purchased service quantity, the HLR 104 removes the unused portion of the purchased service quantity from the service profile of the buyer 108, without any further change to the service profile of the seller 102.

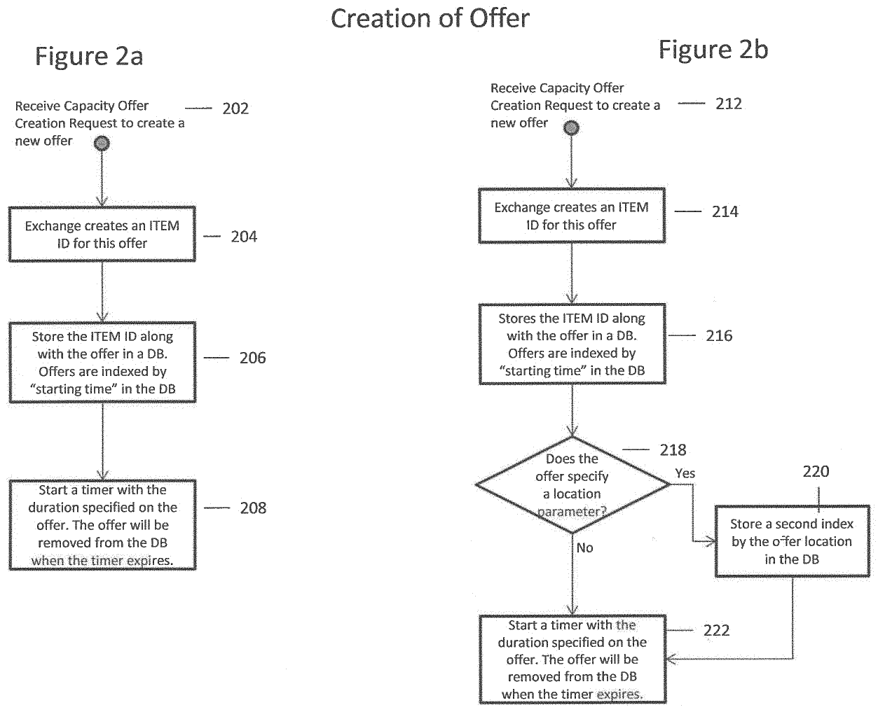

FIG. 2a illustrates creation of an offer in home location register (HLR) in accordance with an embodiment. First, a seller 102 initiates an offer to sell a quantity of service available for use during a specified period of time for a specified price, a capacity offer, in HLR 104 via step 110, as shown in FIG. 1. Once the HLR receives a capacity offer request initiated by the seller, via step 202, it creates an item identifier (item ID) for that offer, via step 204. The HLR then stores the item ID along with the offer in a database, via step 206. Offers may be indexed for example by starting time in the database. The HLR then starts a timer with the duration of the period during which the offered service is valid for use as specified and the offer is removed from the database when the timer expires via step 208.

FIG. 2b illustrates creation of an offer including location in addition to time, according to an embodiment of the invention. A location-based offering indicates that the service will only be provided at the offer price in a specific geographic location. A specific geographical location can be described as a point which is exact location defined by longitude and latitude, or longitude, latitude and altitude. A geographical location can also be defined as circular, for example, within a radius of 5 miles, or as a polygon defined by boundaries. The location can also be defined by cellular service identifier such as international mobile subscriber identifier (IMSI) or mobile identification number (MIN). For example, in case wireless mode of communication, cellular identifier defines a location.

First, a seller 102 initiates an offer to sell a quantity of service available for use during a specified period of time, within a specified geographic location for a specified price, a capacity offer, in HLR 104 via step 110, as shown in FIG. 1. Once the HLR receives a capacity offer request initiated by a seller, via step 212, it creates an item identifier (item ID) for that offer, via step 214. The HLR then stores the item ID along with the offer in a database, via step 216. At this point, the offers may be indexed for example by starting time in the database. The HLR further checks for a location parameter in the offer via step 218. If the offer specifies a location parameter, the offers may be further indexed for example by location in the database via step 220. The HLR then starts a timer with the duration of the period during which the offered service is valid for use as specified and the offer is removed from the database when the timer expires via step 222.

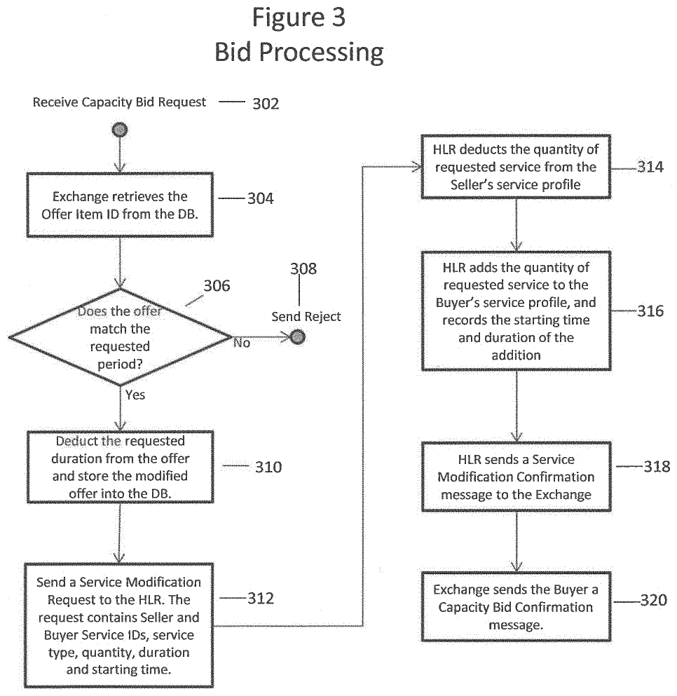

FIG. 3 is a flow diagram illustrating processing capacity discovery requests and capacity offers. Processing of capacity discovery requests and capacity offers begins by matching and publishing capacity offers via step 116 as shown in FIG. 1 and continues with further processing involving addition of purchased quantity to the service profile of a buyer 108 and deducting the same from the service profile of a seller 102. FIG. 3 is a detailed illustration of this process. Bidding starts when an exchange receives a capacity discovery request initiated by a buyer also known as capacity bid request 302.

The exchange then retrieves all capacity offers from the database via step 304 and through a method checks if the capacity bid request matches any capacity offers via step 306. Each capacity offer that does not match the capacity bid request in one or more parameters is rejected via step 308. If a capacity offer matches the capacity bid request, it then deducts the requested capacity from the offer and stores the modified offer into the database via step 310. The exchange then sends a service modification request to the home location register (HLR) via step 312.

The request may include seller and buyer's service profile identifiers and other information about the offer and bid, such as service type and quantity and the time period during which the purchased capacity is valid. The HLR then deducts the quantity of requested service from the seller's service profile via step 314; and adds the quantity of requested service to the buyer's service profile, and records the starting time and duration of the period during which the requested service is valid via step 316. HLR then sends service modification confirmation message to the exchange via step 318, which in turn sends the buyer a capacity bid confirmation message via step 320.

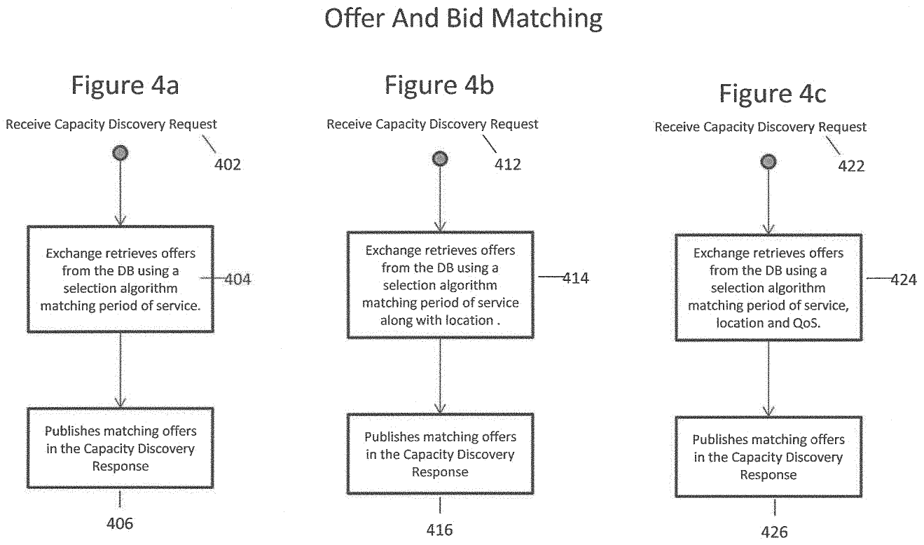

FIG. 4a illustrates the process of matching and publishing of an offer in response to a capacity discovery request initiated by a buyer. Once an exchange receives a capacity discovery request initiated by a buyer step 402, it retrieves offers from the database using a selection algorithm which matches the requested parameters, such as period during which the offered service is valid for use, via step 404. An example of a selection algorithm is shown below.

Selection Algorithm:

Select offers that match the condition below:

EndingTime_{Discovery}>StartingTime_{offer}>StartingTime_{Discovery}

The exchange then publishes matching offers in the capacity discovery response, via step 406. An example of a publishing algorithm is shown below.

### Offer Publishing Algorithm:

(1) Calculate the nearest hours to the StartingTime_{Discovery} and EndingTime_{Discovery}.
(2) Construct an interval in the range: [StartingHour_{Discovery}, EndingHour_{Discovery}]
(3) For each hour in the range, construct a tuple in the following format:
   Hour, Item ID, Price
(4) Send the list of tuples in the Capacity Discovery Response.

FIG. 4b illustrates the process of matching and publishing of an offer in response to a capacity discovery request initiated by a buyer including location along with price, quantity and duration of service, according to another embodiment of the invention. Once an exchange receives a capacity discovery request initiated by a buyer step 412, it retrieves offers from the database using selection algorithm which matches the requested parameters, such as period during which the offered service is valid for use, distance between the offer location and the discovery request location via step 414. An example of a selection algorithm is shown below.

Selection Algorithm:

Select offers that match both conditions below:

EndingTime_{Discovery}>=StartingTime_{Offer}>=StartingTime_{Discovery} (1)

Distance between Offer_{Location} and Discovery_{Location}<=Distance_{Discovery} (2)

However, if the offer does not include a location, or a discovery request does not specify a location or distance, the second condition in the algorithm as shown will always be true.

The exchange then publishes matching offers in the capacity discovery response, via step 416. An example of a publishing algorithm for location along with duration of time of service is shown below.

Offer Publishing Algorithm:
(1) Calculate the nearest hours to the StartingTime_{Discovery} and EndingTime_{Discovery},
(2) Construct an interval in the range: [StartingHour_{Discovery}, EndingHour_{Discovery}]
(3) For each hour in the range, construct a tuple in the following format:
   Hour, Item ID, Price, Location (if present)
(4) Send the list of tuples in the Capacity Discovery Response.

FIG. 4c illustrates the process of matching and publishing of an offer in response to a capacity discovery request initiated by a buyer including quality of service (QoS) in addition to price, quantity, duration of service and location of service, according to an embodiment of the invention. Once an exchange receives a capacity discovery request initiated by a buyer step 422, it retrieves offers from the database using a selection algorithm which matches the requested parameters, such as period during which the offered service is valid for use, distance between the offer location and the discovery request location and QoS via step 424. An example of the selection algorithm is shown below.

Selection Algorithm:

Select offers that match both conditions below:

EndingTime_{Discovery}>=StartingTime_{Offer}>=StartingTime_{Discovery} (1)

Distance between Offer_{Location} and Discovery_{Location}<=Distance_{Discovery} (2)

QoS_{Offer} is equal to QoS_{Discovery} (3)

However, if the offer does not include a location, or a discovery request does not specify a location or distance, the second condition in the algorithm as shown will always be true. Similarly, if the offer does not include QoS, or a discovery request does not specify QoS, the third condition in the algorithm as shown will always be true.

The exchange then publishes matching offers in the capacity discovery response, via step 426. An example of a publishing algorithm for QoS along with duration of time and location of service is shown below.

Offer Publishing Algorithm:
(1) Calculate the nearest hours to the StartingTime_{Discovery} and EndingTime_{Discovery}.
(2) Construct an interval in the range: [StartingHour_{Discovery}, EndingHour_{Discovery}]
(3) For each hour in the range, construct a tuple in the following format:
   Hour, Item ID, Price, Location (if present), QoS (if present)
(4) Send the list of tuples in the Capacity Discovery Response.

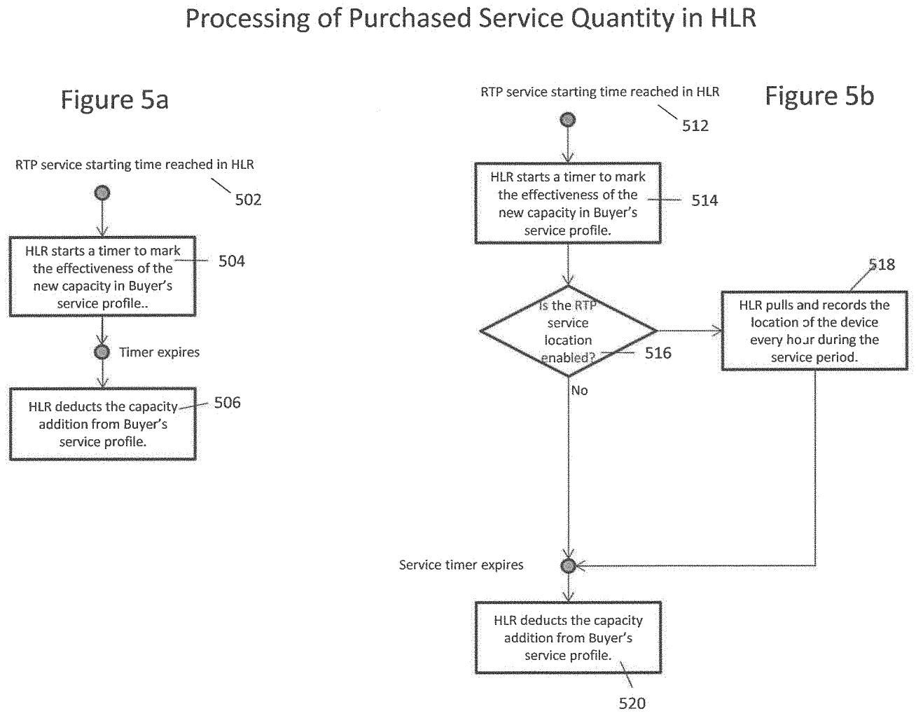

FIG. 5a illustrates the processing of offers to purchase and sale of service valid during specified time period in the HLR of the cellular service provider. Once starting time for when the purchased service valid is reached step 502, HLR starts a timer to mark the effectiveness of the new capacity in buyer's service profile via step 504. When the timer expires, the HLR deducts the capacity addition from the buyer's service profile via step 506. This ensures that the capacity the buyer purchased does not go beyond the period during which the capacity is valid for use.

FIG. 5b illustrates the processing of offers to sell and buy service valid during specified time period along with location in the HLR. Once starting time for when the purchased service valid is reached step 512, HLR starts a timer to mark the effectiveness of the new capacity in buyer's service profile via step 514. HLR checks if the purchased quantity of service is location enabled via step 516, if it is, HLR pulls and records the location of the device every hour during the service period via step 518, allowing the HLR to meter the device with a different price if the device is outside the service area for which the service is purchased. When the timer expires, HLR deducts the capacity addition from the buyer's service profile via step 520. This ensures that the capacity the buyer purchased does not go beyond it's the period during which the capacity is valid for use.

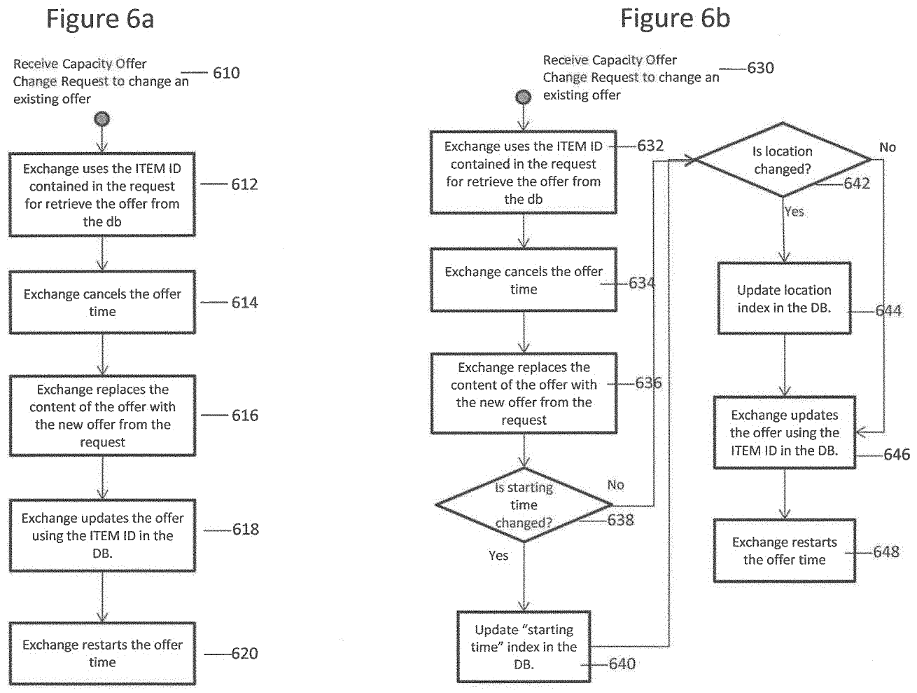

It may be desirable for the seller to change the capacity offer parameters of the offer or the portion of the offer before the purchase of the service quantity by the buyer. FIG. 6a illustrates a first method for the exchange to process a change to a capacity offer according to an embodiment of the invention. Sellers can change parameters of the offer or the portion of the offer including price and “start” and “stop” period i.e. duration of the service any time before the purchase of the service quantity by the buyer. The capacity offer change request can be either initiated by the seller, or by the exchange as part of post-sale processing of the offer, via step 610. The exchange then uses an item ID included in the request to retrieve the offer from the database, via step 612. The offer is then cancelled via step 614, and the content of the offer is replaced, for example, price or duration of the service with the new offer from the request via step 616. The offer is then updated, via step 618 using the item ID in the database and the offer time is restarted, step 620.

FIG. 6b illustrates a second method for the exchange to process a change to a capacity offer according to an embodiment of the invention. As illustrated in FIG. 6b, the home location register can make changes to the offer based on any of the parameters comprising duration of the service offered, location of the service offered, quality of service offered in addition to price, quantity and start time (not shown in figure). Sellers can change any of the parameters of the offer or the portion of the offer including but not limited to price, “start” and “stop” time i.e. duration of the service, location and quality of service any time before the purchase of the service quantity by the buyer. Therefore, the capacity offer change request can be either initiated by the seller, or by the exchange as part of post-sale processing of the offer, via step 630.

The exchange then uses an item ID included in the request to retrieve the offer from the database, via step 632. The exchange then cancels the offer via step 634, and replaces the content of the offer with the new offer from the request via step 636. Exchange then checks for the change in starting time via step 638. If the starting time has changed the exchange updates starting time index in the database via step 640. The Exchange also checks for the change in location via step 642. If the location has changed the exchange updates location index in the database via step 644. Exchange then updates the offer via step 646 using the item ID in the database and restarts the offer time, step 648.

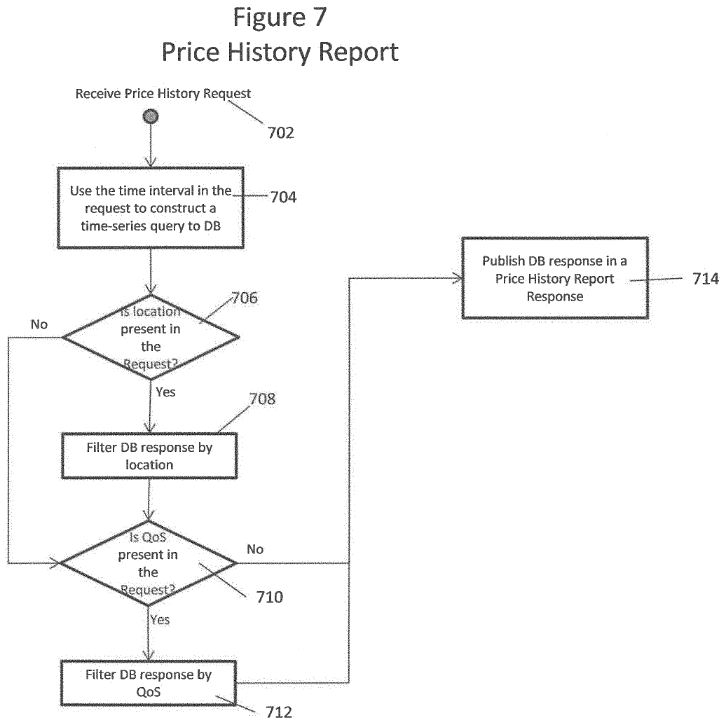

It may be desirable for a seller or a buyer to know historical data related to price based on parameters such as quantity, duration, location and quality of service before initiating either a capacity offer or a capacity request. A seller may also desire to request such history before initiating a request for change. FIG. 7 illustrates the creation of price history report at the request of either the seller or the buyer. The method and system enable a buyer or seller to come up with a price associated with the service to be purchased or sold. As the exchange receives a price history request via step 702; it uses the time interval in the request to construct a time-series query to the database via step 704. It may check if the location is present in the request via step 706, if the location is present; it filters the database response by location via step 708. It may also check if the QoS is present in the request via step 710, if the QoS is present; it filters the database response by QoS via step 712. As shown in the figure, steps 706 and 710 are carried out independent of each other. The exchange then publishes the database response as a price history report via step 714. An example of algorithm used to create a price history report is shown below.

History Report Algorithm:
(1) Calculate the nearest hours to the StartingTime_{request} and EndingTime_{request}.
(2) Construct an interval in the range: [StartingHour_{request}, EndingHour_{request}]
(3) For each hour in the range, construct a tuple in the following format:
   Hour, Item ID, Purchase Price, Location (if present), QoS (if present)
(4) Send the list of tuples in the History Report Response.

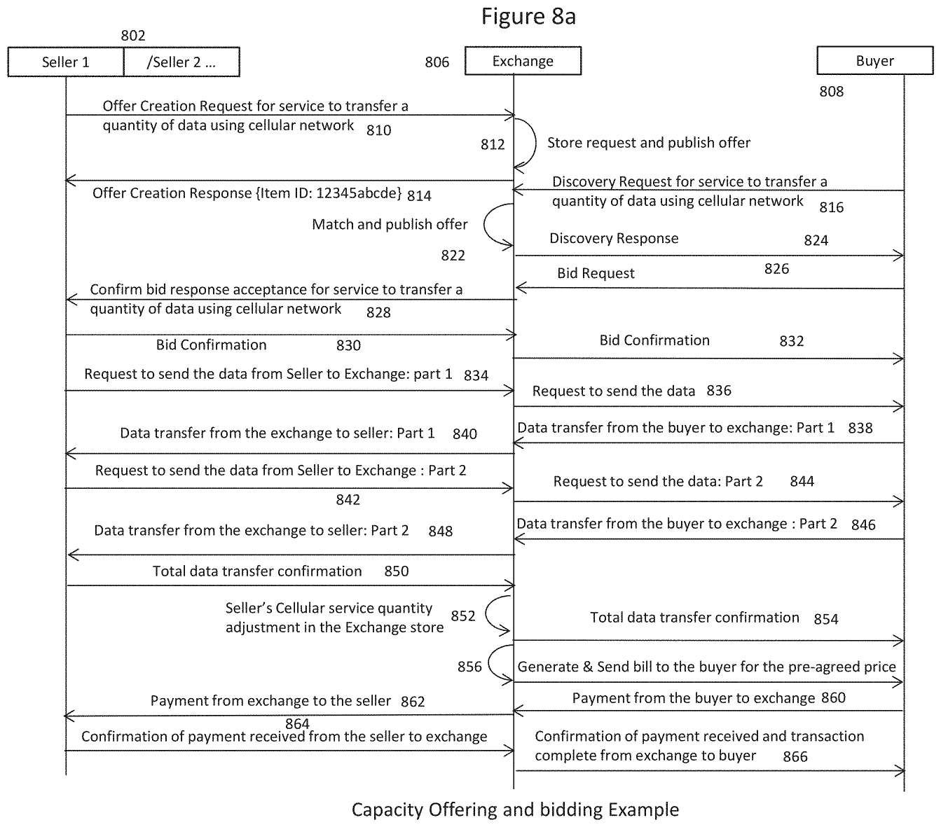

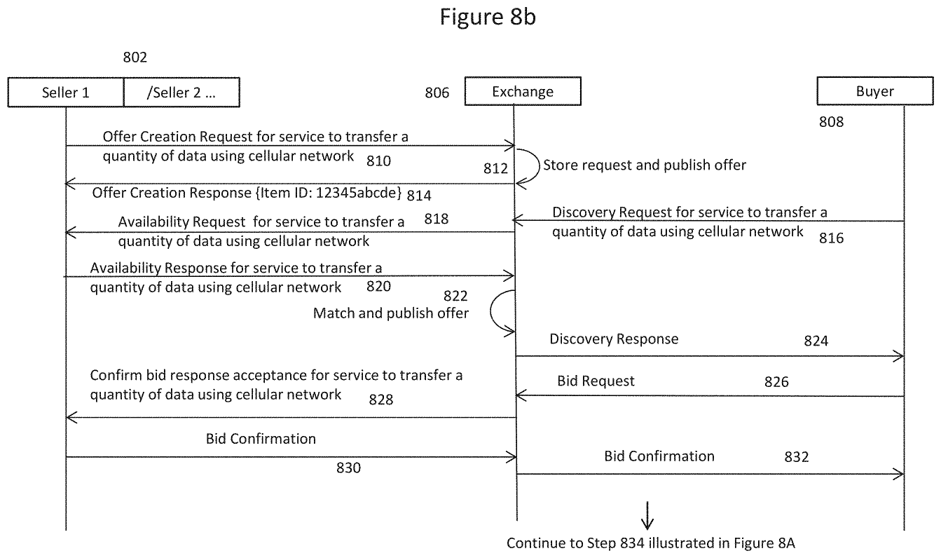

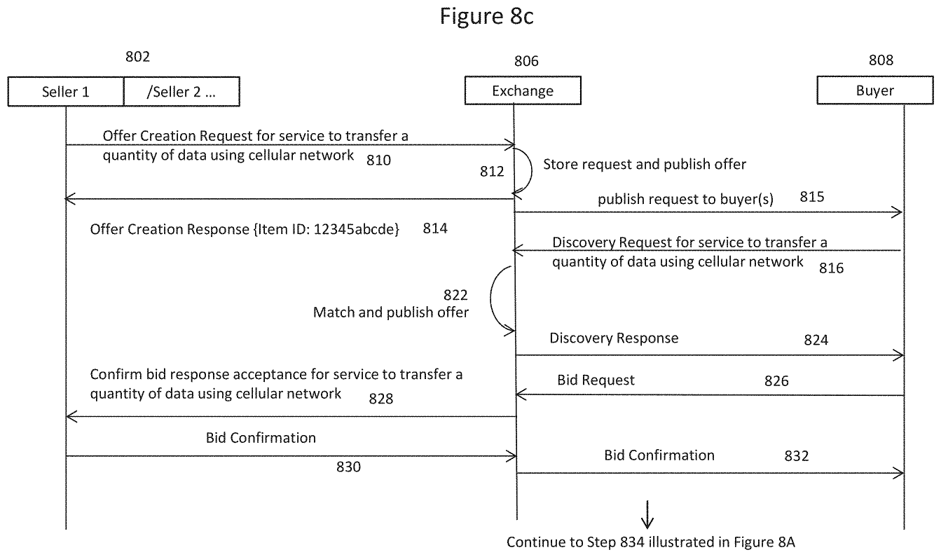

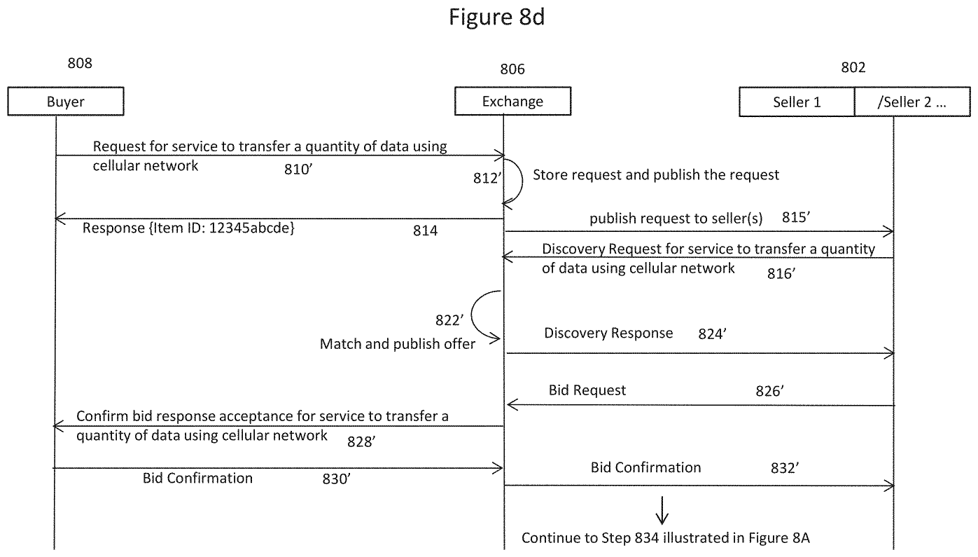

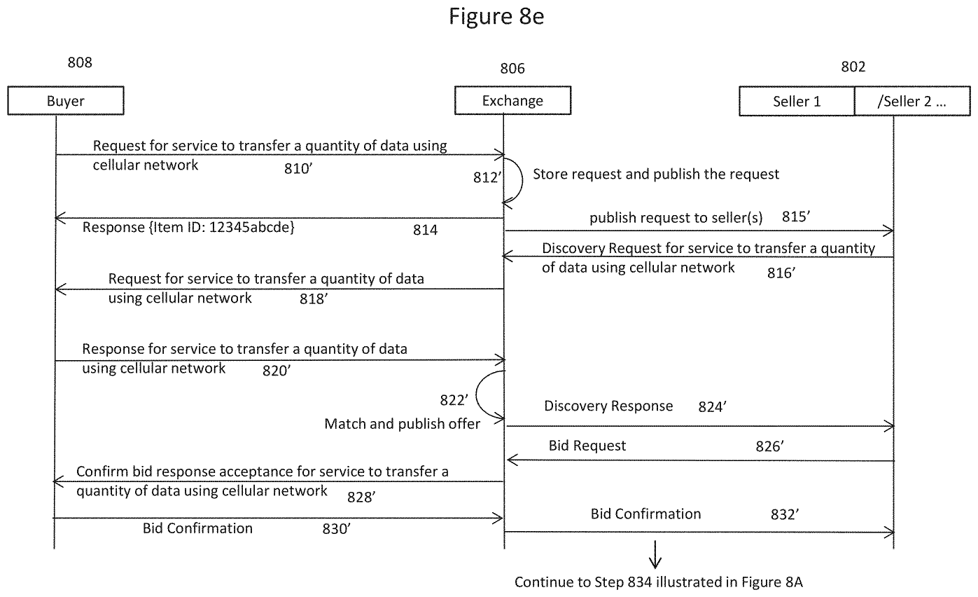

In one or more embodiments, the method, system and computer program product for buying and selling service to transfer a quantity of data using cellular network are disclosed as illustrated in FIGS. 8A through 17 and described in detail below.

For example, a digital billboard may display the same data for a specified duration, after which it will get refreshed. The billboard company may choose to leverage someone else's data plan that has excess data to sell or a service to transfer data to sell. The billboard company may have a set date and time when it expects to refresh its data and may automatically send a request to buy the service for transferring data to replace its content.

In another example, a 3rd-party company may decide to lease some time on the billboard to display their content. The purchase may then be initiated as illustrated in the figures, by a user or by a computer system. The billboard company then knows that on a certain date/time, it needs to replace its content with data from the 3rd-party company. Thus, the billboard company has a set date and time when it expects to refresh its data and may automatically send a request to buy the service for transferring data to replace its content.

In yet another example, Customer A is collecting water meter samples from a vineyard. The amount of data need is small. Customer B has purchased large amounts of data in their monthly recurring charges, and it is not using all of it. If Customer A needs a small amount of data, instead of buying it from a service provider, which may not provide data plans or better rate plans for small amount of data, Customer A may buy it from Customer B, where Customer B provides a service to transfer data for Customer A.

Although, the examples above are used to explain the parameter “amount of data to be transferred”, they may also include parameters such as but not limited to prioritizing data transfer, better rate for data transfer if the seller has excess capacity and wants to offer service at a discounted rate, better rate for data transfer at a particular location and/or time etc. as described in detail in the description accompanying FIGS. 8A through 17 and are within the spirit and scope of the invention.

The sell-purchase of a service to transfer data may be initiated by a user or by a computerized system automatically and may be based on pre-defined criteria.

Although the examples above are provided to give an idea as to how the invention may be used, a person skilled in the art may readily recognize that examples other those described above are also possible and are within the spirit and scope of the invention.

FIG. 8a illustrates a flow diagram illustrating an exemplary offer to provide service to ‘transfer a quantity of data using cellular network’ and discovery request to purchase service to ‘transfer a quantity of data using cellular network’ using an exchange, according to one or more embodiments of the present invention. First, a seller 802 initiates submission of an offer to ‘transfer a quantity of data using cellular network’ to an exchange 806 specifying a quantity of data that may be transferred using seller's service for a fixed duration at a given price via step 810. In an embodiment, the period during which the offered service to ‘transfer a quantity of data’ is valid for use may be in multiples of one hour. Although multiples of one hour are used herein as an example, a person skilled in the art may readily recognize that multiple of any period of time may be used.

The offer to provide service to ‘transfer a quantity of data using cellular network’ provided by the seller may include parameters such as but not limited to type, e.g., data; peak/off-peak quantity, e.g., 50/50 (in MB); service ID, e.g., 555-123456789012; duration, e.g., 7 days; starting time, e.g., YYYY-MM-DD-HH; offer price, e.g., peak/off-peak $0.20/$0.1 per MB, etc. In addition, in an embodiment, the seller 802 may be allowed to change the offer parameters, for example, more/less data, time of transfer, duration of offer etc. after it is submitted. Exchange 806 stores the request via step 812 and may send the offer creation response to the seller 802 via step 814 and may publish all offers over a specified time period, for example, 24 hours, via step 816. The publishing of an offer may mean responding to the buyer's request when the offer is matched with the buyer's request as illustrated by step 822 below or storing and publishing offer before receiving and/or matching with buyer's request as illustrated by step 812. In an embodiment, a buyer's request may include a request generated by a user or generated by a computer system that is looking to transfer data.

A buyer 808 may independently (proactively) or based on the published offer initiate a discovery request for purchasing ‘service to transfer a quantity of data using cellular network’, for example, for any of quantity of data required and the maximum price the buyer 808 is willing to pay, via step 816. The buyer 808 may also specify parameters such as but not limited to type, e.g., data; starting time, e.g., YYYY-MM-DD-HH; duration; quantity, e.g., 40 MB etc.

In an embodiment, the lowest priced offer that matches the requirements of the buyer 808 is determined via step 822 and the exchange 806 notifies the buyer 808 of the matching offer by sending a discovery response to the buyer 808, also known as publishing the matched offer, via step 824 including the details such as but not limited to type, e.g., data; offers, e.g., hour: HH1, item ID: 12345abcde, price: $0.10 per KB; hour: HH2, item ID: 987654321, price: $0.20 per KB etc.

The buyer 808 may then accept the offer by sending a bid request to purchase service to ‘transfer a quantity of data using cellular network’, including parameters such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc. via step 826 to the exchange 806, which then sends a confirmation request to the seller 802 via step 828. Once the confirmation is received by the exchange 804, via step 830, it sends a purchase confirmation for service to transfer a quantity of data to the buyer 808 including details of the purchase such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc., via step 832. The offer is taken off the market after expiration of the offer or sooner if the entire quantities in the offer have been matched with at least one buyer 808 or one or more buyers.

Additionally or alternatively, the buyer may approach the exchange and inform that it needs more capacity and/or parameters other than the ones described in the available offers, or that if there is no offer available at the exchange, the exchange may then contact one or more sellers and proceed with steps 818 and 820 as shown in FIG. 8b. The exchange may then proceed with matching and publishing the offer, discovery response etc. as illustrated in FIG. 8a.

Additionally or alternatively, the offer may be broadcast to one or more buyers via step 815, and the buyer may respond via step 816 as illustrated in FIG. 8c. The exchange may then proceed with matching and publishing the offer, discovery response etc. as illustrated in FIG. 8a.

In any of the embodiments described throughout the specification, a buyer and/or a seller may be proactive or reactive, for example, the buyer or the seller may initiate a request for services or an offer to provide services. Further, a buyer and/or a seller may be defined as an entity including a human or a computerized system. Similarly, the exchange may be computerized platform to carry out the steps described throughout the specification.

Alternatively, in an embodiment, instead of seller initiating an offer to provide service to ‘transfer a quantity of data using cellular network’, a buyer may initiate an offer to purchase ‘service to transfer a quantity of data using cellular network’ also referred to herein as ‘a request’ for ‘service to transfer a quantity of data using cellular network’ to check availability of such service as illustrated in FIG. 80. Similar to the offer initiated by the seller 802, the offer created by the buyer 808 may also include the parameters such as but not limited to type, e.g., data; peak/off-peak quantity, e.g., 50/50 (in MB); service ID, e.g., 555-123456789012; duration, e.g., 7 days; starting time, e.g., YYYY-MM-DD-HH; offer price, e.g., peak/off-peak $0.20/$0.1 per MB, etc.

In addition, in an embodiment, the buyer 808 may be allowed to change the offer parameters, for example, more/less data, time of transfer, duration of offer etc. after it is submitted. Exchange 806 stores the request via step 812′ and may send the offer creation response to the buyer 808 via step 814′ and may publish all offers over a specified time period, for example, 24 hours, via step 815′. The seller may initiate a discovery request for service to transfer a quantity of data using cellular network via step 816′. The publishing of an offer may mean responding to the seller's request when the offer is matched with the seller's request as illustrated by step 822′ below or storing and publishing offer before receiving and/or matching with seller's request as illustrated by step 812′.

In an embodiment, a seller's offer and/or a buyer's request may include a request generated by a user or generated by a computer system. Similarly, in an embodiment, a buyer's offer for requesting service to transfer data and/or a seller's request to provide service to transfer data may include an offer and/or a request generated by a user or generated by a computer system.

A seller 802 may initiate a discovery request for selling ‘service to transfer a quantity of data using cellular network’, for example, for any of quantity of data required and the maximum price the seller 802 is willing to accept, via step 816′. The seller 802 may also specify parameters such as but not limited to type, e.g., data; starting time, e.g., YYYY-MM-DD-HH; duration; quantity, e.g., 40 MB etc.

Additionally or alternatively, in an embodiment, the seller may approach the exchange and inform it that there may be lesser capacity and/or different parameters other than the ones described in the available request 815′ from the buyer, the exchange may then contact one or more buyers via steps 818′ and the buyer 808 may respond via step 820′ as shown in FIG. 8e.

In an embodiment, the buyer's request for service may be divided into more than one segments based on availability of data transfer services by the seller/s and may be purchased from one or more sellers based on availability.

In an embodiment, the lowest priced offer that matches the requirements of the seller 802 is determined via step 822′ and the exchange 806 notifies the seller 802 of the matching offer by sending a discovery response to the seller 802, also known as publishing the matched offer, via step 824′ including the details such as but not limited to type, e.g., data; offers, e.g., hour: HH1, item ID: 12345abcde, price: $0.10 per KB; hour: HH2, item ID: 987654321, price: $0.20 per KB etc.

The seller 802 may then accept the offer by sending a bid request to purchase service to ‘transfer a quantity of data using cellular network’, including parameters such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc. via step 826′ to the exchange 806, which then sends a confirmation request to the buyer 808 via step 828′. Once the confirmation is received by the exchange 804, via step 830′, it sends a purchase confirmation for service to transfer a quantity of data to the seller 802 including details of the purchase such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc., via step 832′. The offer is taken off the market after expiration of the offer or sooner if the entire quantities in the offer have been matched with at least one seller 802 or one or more sellers. Once the purchase is completed, the actual process of transferring the data continues as follows.

In an embodiment, the seller 802 may send a request to send the data to be transferred including the purchase details of the service to transfer a quantity of data such as but not limited to type, e.g., data; item ID, e.g., 12345abcde; data quantity, e.g., 10 MB; service ID, e.g., 999-098765432112 etc.to the exchange 806 via step 834, which is then forwarded to the buyer 808 via step 836. The amount of data specified in the purchase contract is then transferred from the buyer 808 to the exchange 806 via step 838 and is forwarded to the seller 802 via step 840.

As illustrated in the above example, the data to be transferred may be divided into in multiple segments and may involve multiple sellers, each with same or different quantity of data transfer service available to transfer the data. Steps 834 to 840 are repeated until the entire quantity of data to be transferred is transferred to the one or more sellers involved in the transfer. For example, when some portion of the total data to be transferred is transferred to the seller, remaining data, for example, as shown 10 MB of data is transferred and 30 MB data is remaining, until total quantity of data is transferred. As the remaining data may be transferred in one or more segments, each request will include the amount of data to be transferred along with details of the purchase agreement, for example, type, e.g., data; item ID, e.g., 12345abcde; data quantity, e.g., 30 MB; service ID, e.g., 999-098765432112 etc.

The steps 840 and 848 may be feasible when the seller owns/manages connectivity infrastructure (e.g., MNO/MVNOs). For individual sellers who don't own the connectivity infrastructure, sellers (e.g., MNO/MVNO subscribers), the exchange may store the data to be transferred and then transmit/transfer the data using its local infrastructure on behalf of the seller using for example, seller's data transfer capacity and deducting it from the seller's account.

Once the entire quantity of data to be transferred is transferred, total data transfer confirmation is sent to the exchange 806 with details of the transfer including but not limited to type, e.g., data; item ID, e.g., 12345abcde; data quantity, e.g., 40 MB; service ID, e.g., 999-098765432112; starting time, e.g., YYYY-MM-DD-HH; ending time, e.g., YYYY-MM-DD-HH etc. via step 850. The exchange 806 then adjusts the seller's available quantity of data transfer service in exchange store via step 852 and sends total data transfer confirmation to the buyer 808 via step 854.

The exchange 806 may then generate and send bill to the buyer for the pre-agreed price with details such as but not limited to type, e.g., data; item ID, e.g., 12345abcde; data quantity, e.g., 40 MB; service ID, e.g., 999-098765432112; and bill amount etc. via step 856. The buyer and seller may complete the transaction including payment via exchange as illustrated by steps 860-866.

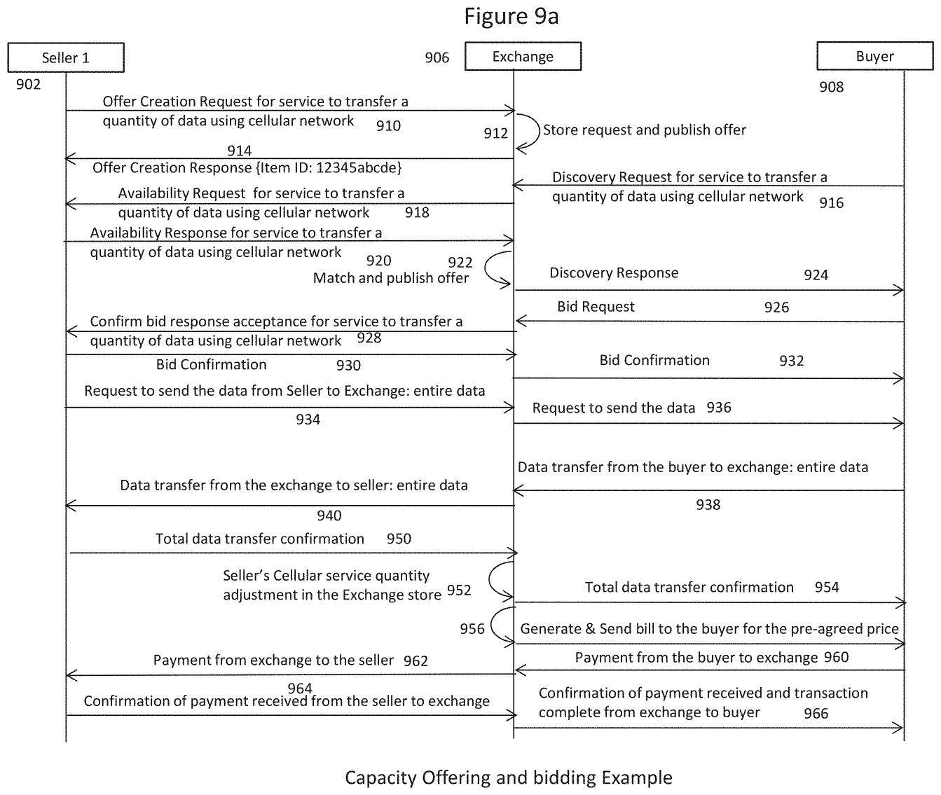

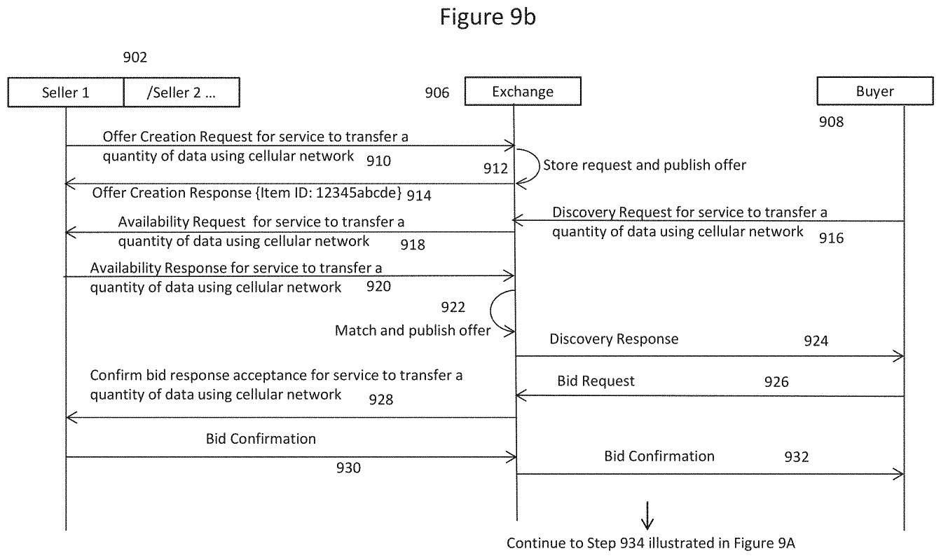

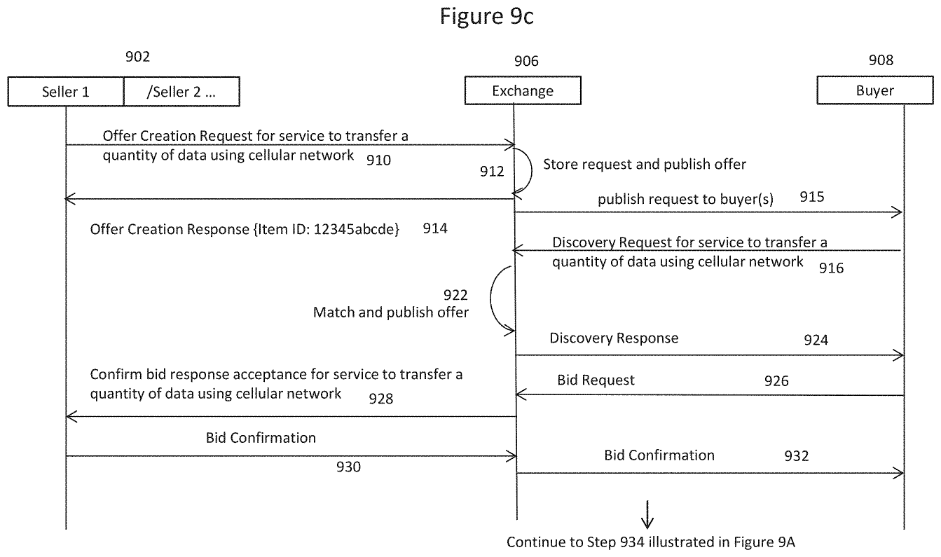

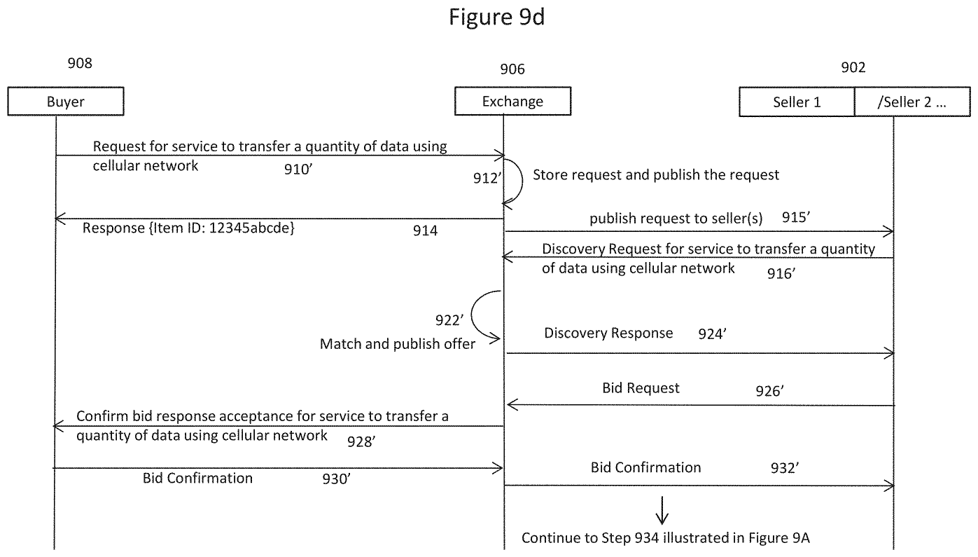

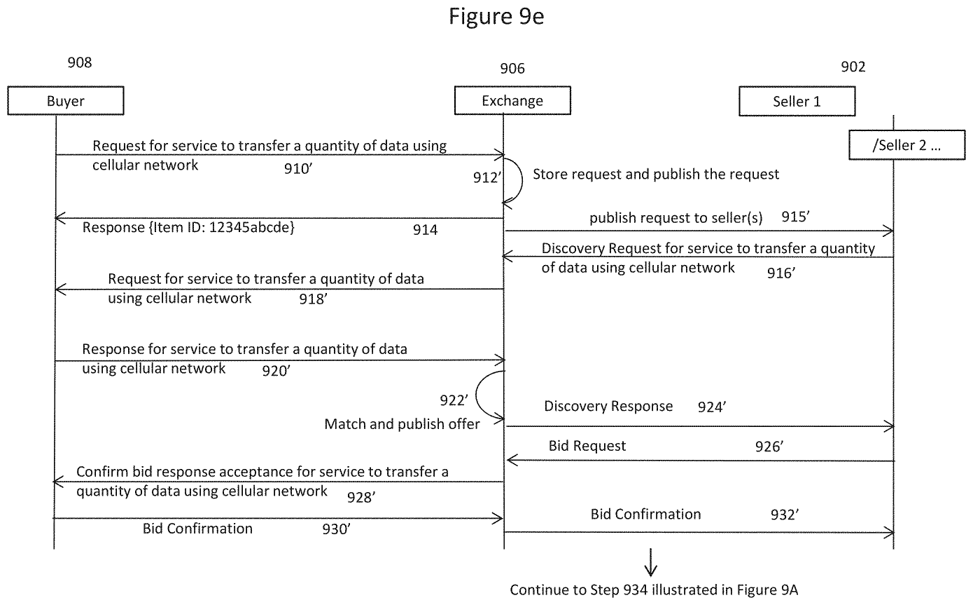

FIG. 9a illustrates a flow diagram illustrating an exemplary offer to provide service to ‘transfer a quantity of data using cellular network’ and discovery request to purchase service to ‘transfer a quantity of data using cellular network’ using an exchange, according to one or more embodiments of the present invention. First, a seller 902 initiates submission of an offer to provide service to ‘transfer a quantity of data using cellular network’ to an exchange 906 specifying a quantity of data that may be transferred using seller's service for a fixed duration at a given price via step 910. In an embodiment, the period during which the offered service to ‘transfer a quantity of data’ is valid for use may be in multiples of one hour. Although multiples of one hour are used herein as an example, a person skilled in the art may readily recognize that multiple of any period of time may be used. The offer to provide service to ‘transfer a quantity of data using cellular network’ provided by the seller may include parameters such as but not limited to type, e.g., data; peak/off-peak quantity, e.g., 50/50 (in MB); service ID, e.g., 555-123456789012; duration, e.g., 7 days; starting time, e.g., YYYY-MM-DD-HH; offer price, e.g., peak/off-peak $0.20/$0.1 per MB, etc. In addition, in an embodiment, the seller 902 may be allowed to change the offer parameters, for example, more/less data, time of transfer, duration of offer etc. after it is submitted. Exchange 906 stores the request via step 912 and may send the offer creation response to the seller 902 via step 914 and may publish all offers over a specified time period, for example, 24 hours, via step 916. The publishing of an offer may mean responding to the buyer's request when the offer is matched with the buyer's request as illustrated by step 922 below or storing and publishing offer before receiving and/or matching with buyer's request as illustrated by step 912.

A buyer 908 may independently (proactively) or based on the published offer initiate a discovery request for purchasing service to ‘transfer a quantity of data using cellular network’, for example, for any of quantity of data required and the maximum price the buyer 908 is willing to pay, via step 916. The buyer 908 may also specify parameters such as but not limited to type, e.g., data; starting time, e.g., YYYY-MM-DD-HH; duration; quantity, e.g., 40 MB etc.

In an embodiment, the lowest priced offer that matches the requirements of the buyer 908 is determined via step 922 and the exchange 906 notifies the buyer 908 of the matching offer by sending a discovery response to the buyer 908, also known as publishing the matched offer, via step 924 including the details such as but not limited to type, e.g., data; offers, e.g., hour: HH1, item ID: 12345abcde, price: $0.10 per KB; hour: HH2, item ID: 987654321, price: $0.20 per KB etc.

The buyer 908 may then accept the offer by sending a bid request to purchase service to ‘transfer a quantity of data using cellular network’, including parameters such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc. via step 926 to the exchange 906, which then sends a confirmation request to the seller 902 via step 928. Once the confirmation is received by the exchange 904, via step 930, it sends a purchase confirmation for service to transfer a quantity of data to the buyer 908 including details of the purchase such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc., via step 932. The offer is taken off the market after expiration of the offer or sooner if the entire quantities in the offer have been matched with at least one buyer 908 or one or more buyers.

Additionally or alternatively, the buyer may approach the exchange and inform it that it needs more capacity and/or parameters other than the ones described in the available offers, or that there is no offer available at the exchange, the exchange may then contact one or more sellers and proceed with steps 918 and 920 as shown in FIG. 9B. The exchange may then proceed with matching and publishing the offer, discovery response etc. as illustrated in FIG. 9a.

Additionally or alternatively, the offer may be broadcast to one or more buyers via step 915, and the buyer may respond via step 916 as illustrated in FIG. 9c. The exchange may then proceed with matching and publishing the offer, discovery response etc. as illustrated in FIG. 9a.

In any of the embodiments described throughout the specification, a buyer and/or a seller may be proactive or reactive, for example, the buyer or the seller may initiate a request for services or an offer to provide services. Further, a buyer and/or a seller may be defined as an entity including a human or a computerized system. Similarly, the exchange may be computerized platform to carry out the steps described throughout the specification.

Alternatively, in an embodiment, instead of seller initiating an offer to provide service to ‘transfer a quantity of data using cellular network’, a buyer may initiate an offer to purchase ‘service to transfer a quantity of data using cellular network’ also referred to herein as ‘a request’ for ‘service to transfer a quantity of data using cellular network’ to check availability of such service as illustrated in FIG. 9D. Similar to the offer initiated by the seller 902, the offer created by the buyer 908 may also include the parameters such as but not limited to type, e.g., data; peak/off-peak quantity, e.g., 50/50 (in MB); service ID, e.g., 555-123456789012; duration, e.g., 7 days; starting time, e.g., YYYY-MM-DD-HH; offer price, e.g., peak/off-peak $0.20/$0.1 per MB, etc.

In addition, in an embodiment, the buyer 808 may be allowed to change the offer parameters, for example, more/less data, time of transfer, duration of offer etc. after it is submitted. Exchange 906 stores the request via step 912′ and may send the offer creation response to the buyer 908 via step 914′ and may publish all offers over a specified time period, for example, 24 hours, via step 916′. The publishing of an offer may mean responding to the seller's request when the offer is matched with the seller's request as illustrated by step 922′ below or storing and publishing offer before receiving and/or matching with seller's request as illustrated by step 912′.

In an embodiment, a seller's offer and/or a buyer's request may include a request generated by a user or generated by a computer system. Similarly, in an embodiment, a buyer's offer for requesting service to transfer data and/or a seller's request to provide service to transfer data may include an offer and/or a request generated by a user or generated by a computer system.

A seller 902 may initiate a discovery request for selling ‘service to transfer a quantity of data using cellular network’, for example, for any of quantity of data required and the maximum price the seller 902 is willing to accept, via step 916′. The seller 902 may also specify parameters such as but not limited to type, e.g., data; starting time, e.g., YYYY-MM-DD-HH; duration; quantity, e.g., 40 MB etc.

Additionally or alternatively, in an embodiment, the seller may approach the exchange and inform it that there may be lesser capacity and/or different parameters other than the ones described in the available request 915′ from the buyer, the exchange may then contact one or more buyers via steps 918′ and the buyer 808 may respond via step 920′ as shown in FIG. 9e.

In an embodiment, the buyer's request for service may be divided into more than one segments based on availability of data transfer services by the seller/s and may be purchased from one or more sellers based on availability.

In an embodiment, the lowest priced offer that matches the requirements of the seller 902 is determined via step 922′ and the exchange 906 notifies the seller 902 of the matching offer by sending a discovery response to the seller 902, also known as publishing the matched offer, via step 924′ including the details such as but not limited to type, e.g., data; offers, e.g., hour: HH1, item ID: 12345abcde, price: $0.10 per KB; hour: HH2, item ID: 987654321, price: $0.20 per KB etc.

The seller 902 may then accept the offer by sending a bid request to purchase service to ‘transfer a quantity of data using cellular network’, including parameters such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc. via step 926′ to the exchange 806, which then sends a confirmation request to the buyer 908 via step 928′. Once the confirmation is received by the exchange 904, via step 930′, it sends a purchase confirmation for service to transfer a quantity of data to the seller 902 including details of the purchase such as but not limited to type, e.g., data; item ID, e.g., 12345abcde; price, e.g., $0.10; service ID, e.g., 999-098765432112; starting time, e.g., YYYY-MM-DD-HH; duration, e.g., 7 days etc., via step 932′. The offer is taken off the market after expiration of the offer or sooner if the entire quantities in the offer have been matched with at least one seller 902 or one or more sellers. Once the purchase is completed, the actual process of transferring the data continues as follows.

In an embodiment, the seller 902 may send a request to send the entire quantity of data to be transferred including the purchase details of the service to transfer a quantity of data such as but not limited to type, e.g., data; item ID, e.g., 12345abcde; data quantity, e.g., 40 MB; service ID, e.g., 999-098765432112 etc.to the exchange 906 via step 934, which is then forwarded to the buyer 908 via step 936. The entire quantity of data specified in the purchase contract is then transferred from the buyer 908 to the exchange 906 via step 938 and is forwarded to the seller 902 via step 940. This step may be feasible when the seller of the service owns/manages connectivity infrastructure (e.g., MNO/MVNOs). For individual sellers who don't own the connectivity infrastructure, sellers (e.g., MNO/MVNO subscribers), the exchange may store the data to be transferred and then transmit/transfer the data using its local infrastructure on behalf of the seller using for example, seller's data transfer capacity and deducting it from the seller's account.

Once the entire quantity of data to be transferred is transferred, total data transfer confirmation is sent to the exchange 906 with details of the transfer including but not limited to type, e.g., data; item ID, e.g., 12345abcde; data quantity, e.g., 40 MB; service ID, e.g. 999-098765432112; starting time, e.g., YYYY-MM-DD-HH; ending time, e.g., YYYY-MM-DD-HH etc. via step 950. The exchange 906 then adjusts the seller's available quantity of data transfer service in exchange store via step 952 and sends total data transfer confirmation to the buyer 908 via step 954.

The exchange 906 may then generate and send bill to the buyer for the pre-agreed price with details such as but not limited to type, e.g., data; item ID, e.g., 12345abcde; data quantity, e.g., 40 MB; service ID, e.g., 999-098765432112; and bill amount etc. via step 956. The buyer and seller may complete the transaction including payment via exchange as illustrated by steps 960-966.

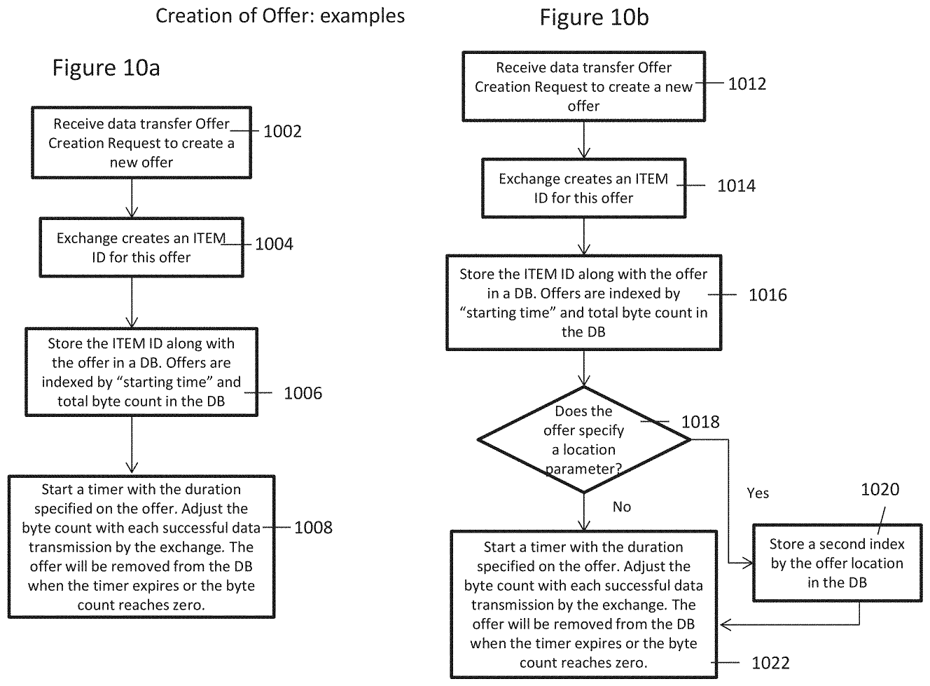

FIGS. 10a and 10b illustrate creation of offers to transfer a quantity of data using cellular network in an exchange according to one or more embodiments of the present invention. FIG. 10a is a detailed illustration of this process where offers are indexed by starting time and total byte count in the database. FIG. 10b is a detailed illustration of this process where offers are indexed by starting time and total byte count in the database along with a location parameter. Although the following description uses an offer to sell ‘service to transfer a quantity of data using cellular network’, a person skilled in the art may easily understand that the process flow illustrated in FIGS. 10a and 10b may similarly work for an offer to buy ‘service to transfer a quantity of data using cellular network’ created by a buyer.

Creation of an offer starts when an exchange receives a data transfer offer creation request to create a new offer initiated by a seller via step 1002 as illustrated in FIG. 10a or via step 1012 as illustrated in FIG. 10b. The exchange then creates an item identifier also referred to as Item ID via step 1004 as illustrated in FIG. 10a or via step 1014 as illustrated in FIG. 10b. This item ID is then stored along with the offer in the database via step 1006 as illustrated in FIG. 10a or via step 1016 as illustrated in FIG. 10b. As illustrated in FIG. 10a, the offers are indexed by starting time and total byte count in the database via step 1006. Similarly, as illustrated in FIG. 10b, the offers are indexed by starting time and total byte count in the database via step 1016 along with a location parameter via step 1020.

The exchange may start a timer with the duration specified on the offer via step 1008 as illustrated in FIG. 10a or via step 1022 as illustrated in FIG. 10b and adjust the byte count with each successful data transmission by the exchange. The offer may be removed from the database when the timer expires, or the byte count reaches zero.

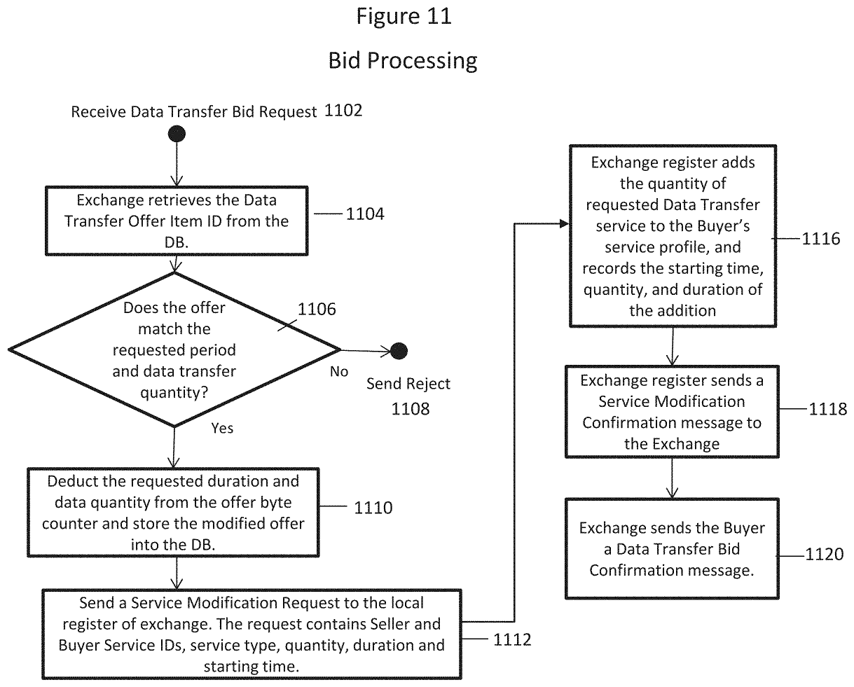

FIG. 11 illustrates creation of an exemplary bid processing for an offer to transfer a quantity of data using cellular network in an exchange, according to one or more embodiments of the invention. Although the following description uses an offer to sell ‘service to transfer a quantity of data using cellular network’, a person skilled in the art may easily understand that the process flow illustrated in FIGS. 11a and 11b may similarly work for an offer to buy ‘service to transfer a quantity of data using cellular network’ created by a buyer.

Processing of data transfer discovery requests and data transfer offers begins by matching and publishing offers via step 822 and/or step 922 as shown in FIGS. 8a-e and 9a-e respectively. Bidding starts when an exchange receives a data transfer discovery request initiated by a buyer via step 1102.

The exchange then retrieves all data transfer offers from the database via step 1104 and through a method checks if the data transfer bid request matches any data transfer offers via step 1106, for example, if the offer matches the requested period and data transfer quantity in the bid request, etc. Each data transfer offer that does not match the data transfer bid request in one or more parameters is rejected via step 1108. If a data transfer offer matches the data transfer bid request, it then deducts the requested quantity of data transfer from the offer and stores the modified offer into the database via step 1110. The exchange then sends a service modification request to the local register of the exchange via step 1112.

The request may include seller and buyer's service profile identifiers and other information about the offer and bid, such as service type and quantity and the time period during which the purchased data transfer service is valid. The exchange register then adds the quantity of requested data transfer service to the buyer's service profile, and records the starting time, quantity, and duration of the addition via step 1116. The exchange register then sends service modification confirmation message to the exchange via step 1118, which in turn sends the buyer a data transfer bid confirmation message via step 1120.

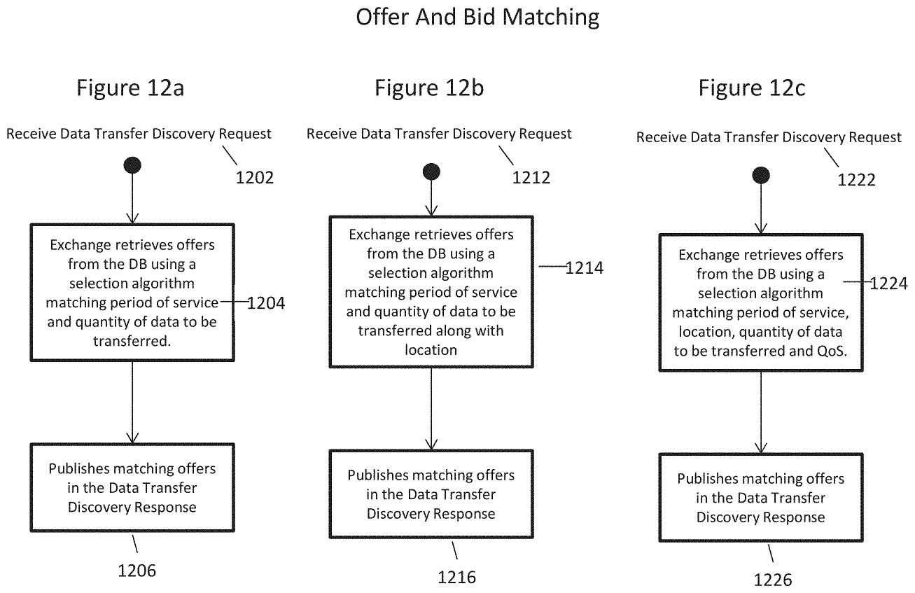

FIGS. 12 a-c are flow diagrams illustrating exemplary methods of matching and publishing an offer to transfer a quantity of data using cellular network in response to a discovery request to transfer a quantity of data using cellular network initiated by a buyer according to one or more embodiments of the invention. Processing of data transfer discovery requests and data transfer offers begins by matching and publishing capacity offers via step 822 or step 922 as shown in FIGS. 8a-e and 9a-e respectively. Bidding starts when an exchange receives a data transfer discovery request initiated by a buyer also known as data transfer bid request via step 1202 or step 1212 or step 1222 as illustrated in FIGS. 12a, 12b and 12c respectively.

Although the following description uses an offer to sell ‘service to transfer a quantity of data using cellular network’, a person skilled in the art may easily understand that the process flow illustrated in FIGS. 12a, 12b and 12c may similarly work for an offer to buy ‘service to transfer a quantity of data using cellular network’ created by a buyer.

The exchange then retrieves all data transfer offers from the database and using a selection algorithm checks if the capacity bid request matches any data transfer offers via step 1204/1214/1224 as illustrated in FIGS. 12a, 12b and 12c respectively. For example, FIG. 12a illustrates matching period of service and quantity of data to be transferred, FIG. 12b illustrates matching period of service and quantity of data to be transferred along with location and FIG. 12c illustrates matching period of service, location, quantity of data to be transferred and quality of service (QoS). The exchange may then publish the matching offers as the data transfer discovery response via step 1206 or step 1216 or step 1226 as illustrated in FIGS. 12a, 12b and 12c respectively.

For example, once an exchange receives a capacity discovery request initiated by a buyer step 1202, it retrieves offers from the database using a selection algorithm which matches the requested parameters, such as period during which the offered service is valid for use, via step 1204. An example of a selection algorithm is shown below.

Selection Algorithm:

Select offers that match the condition below:

EndingTime_{Discovery}>StartingTime_{Offer}>StartingTime_{Discovery}

The exchange then publishes matching offers in the capacity discovery response, via step 1206. An example of a publishing algorithm is shown below.

### Offer Publishing Algorithm:

(5) Calculate the nearest hours to the StartingTime_{Discovery} and EndingTime_{Discovery}.
(6) Construct an interval in the range: [StartingHour_{Discovery}, EndingHour_{Discovery}]
(7) For each hour in the range, construct a tuple in the following format:
   Hour, Item ID, Price
(8) Send the list of tuples in the Capacity Discovery Response.

FIG. 12b illustrates the process of matching and publishing of an offer in response to a discovery request to transfer a quantity of data using cellular network initiated by a buyer including location along with price and duration of service, according to one or more embodiments of the invention. Once an exchange receives a capacity discovery request initiated by a buyer step 1212, it retrieves offers from the database using selection algorithm which matches the requested parameters, such as period during which the offered service is valid for use, distance between the offer location and the discovery request location via step 1214. An example of a selection algorithm is shown below.

Selection Algorithm:

Select offers that match both conditions below:

EndingTime_{Discovery}>=StartingTime_{Offer}>=StartingTime_{Discovery} (1)

Distance between Offer_{Location} and Discovery_{Location}<=Distance_{Discovery} (2)

However, if the offer does not include a location, or a discovery request does not specify a location or distance, the second condition in the algorithm as shown will always be true.

The exchange then publishes matching offers in the capacity discovery response, via step 1216. An example of a publishing algorithm for location along with duration of time of service is shown below.

Offer Publishing Algorithm:
(5) Calculate the nearest hours to the StartingTime_{Discovery} and EndingTime_{Discovery},
(6) Construct an interval in the range: [StartingHour_{Discovery}, EndingHour_{Discovery}]
(7) For each hour in the range, construct a tuple in the following format:
   Hour, Item ID, Price, Location (if present)
(8) Send the list of tuples in the Capacity Discovery Response.

FIG. 12c illustrates the process of matching and publishing of an offer in response to a discovery request to transfer a quantity of data using cellular network initiated by a buyer including quality of service (QoS) in addition to time and location, according to one or more embodiments of the invention. Once an exchange receives a capacity discovery request initiated by a buyer step 1222, it retrieves offers from the database using a selection algorithm which matches the requested parameters, such as period during which the offered service is valid for use, distance between the offer location and the discovery request location and QoS via step 1224. An example of the selection algorithm is shown below.

Selection Algorithm:

Select offers that match both conditions below:

EndingTime_{Discovery}>=StartingTime_{Offer}>=StartingTime_{Discovery} (1)

Distance between Offer_{Location} and Discovery_{Location}<=Distance_{Discovery} (2)

QoS_{Offer} is equal to QoS_{Discovery} (3)

However, if the offer does not include a location, or a discovery request does not specify a location or distance, the second condition in the algorithm as shown will always be true. Similarly, if the offer does not include QoS, or a discovery request does not specify QoS, the third condition in the algorithm as shown will always be true.

The exchange then publishes matching offers in the capacity discovery response, via step 1226. An example of a publishing algorithm for QoS along with duration of time and location of service is shown below.

Offer Publishing Algorithm:
(5) Calculate the nearest hours to the StartingTime_{Discovery} and EndingTime_{Discovery}.
(6) Construct an interval in the range: [StartingHour_{Discovery}, EndingHour_{Discovery}]
(7) For each hour in the range, construct a tuple in the following format:
   Hour, Item ID, Price, Location (if present), QoS (if present)
(8) Send the list of tuples in the Capacity Discovery Response.

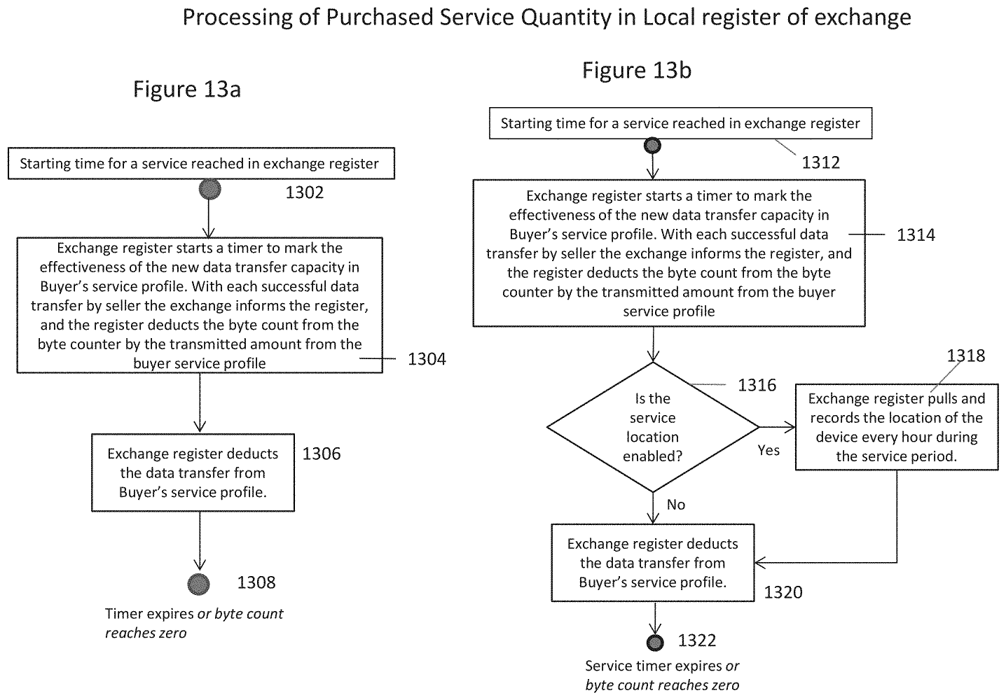

FIG. 13a illustrates the processing of offers to purchase and sale of service to transfer a quantity of data using cellular network valid during specified time period in the exchange register of the cellular service provider, according to one or more embodiments of the invention. For example, once the starting time for a service to transfer a quantity of data using cellular network is reached in exchange register, 1302, exchange register starts a timer to mark the effectiveness of the new data transfer capacity in buyer's service profile. With each successful data transfer by seller the exchange informs the register, and the register deducts the byte count from the byte counter by the transmitted amount from the buyer service profile via step 1304. The exchange register continues deducting the quantity of data transferred from Buyer's service profile via step 1306 until the timer expires or byte counts reaches zero 1308.

FIG. 13b illustrates the processing of offers to sell and purchase service to transfer a quantity of data using cellular network valid during specified time period along with location in the exchange register, according to one or more embodiments of the invention. For example, once the starting time for a service to transfer a quantity of data using cellular network is reached in exchange register, 1312, exchange register starts a timer to mark the effectiveness of the new data transfer capacity in buyer's service profile. With each successful data transfer by the seller, the exchange informs the register, and the register deducts the byte count from the byte counter by the transmitted amount from the buyer service profile via step 1314. The exchange checks if the service location enabled, if yes, the exchange register pulls and records the location of the device every hour during the service period and continues to the next step 1320. If not, the exchange register continues to the next step 1320, where it deducts the quantity of data transferred from Buyer's service profile via step 1320 until the timer expires or byte counts reaches zero 1322.

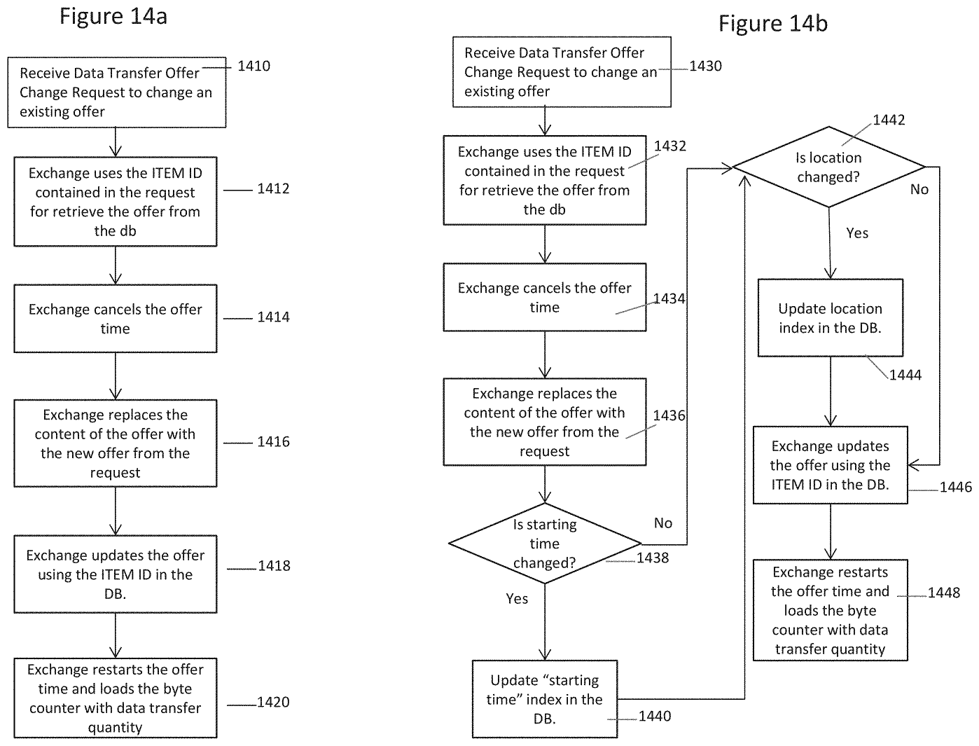

FIG. 14a illustrates a method for the exchange to process a change to an offer to transfer a quantity of data using cellular network, according to one or more embodiments of the invention. Although the following description uses an offer to sell ‘service to transfer a quantity of data using cellular network’, a person skilled in the art may easily understand that the process flow illustrated in FIGS. 14a and 14b may similarly work for an offer to buy ‘service to transfer a quantity of data using cellular network’ created by a buyer.

For example, the exchange receives a data transfer offer change request to change an existing offer via step 1410. The exchange uses the item ID included in the request for retrieve the offer from the database via step 1412. The exchange cancels the offer time via step 1414. The exchange replaces the content of the offer with the new offer from the request via step 1416. The exchange updates the offer using the item ID in the database via step 1418. The exchange restarts the offer time and loads the byte counter with data transfer quantity via step 1420.

FIG. 14b illustrates a method for the exchange to process a change to an offer to transfer a quantity of data using cellular network, according to one or more embodiments of the invention. For example, the exchange receives a data transfer offer change request to change an existing offer via step 1430. The exchange uses the item ID included in the request for retrieve the offer from the database via step 1432. The exchange cancels the offer time via step 1434. The exchange replaces the content of the offer with the new offer from the request via step 1436. The exchange checks if the starting time in the offer has changed via step 1438. If it has, it updates the “starting time” index in the database via step 1440 and continues to the next step 1442. If the starting time in the offer has not changed it continues checking if the next parameter is changed, for example, location via step 1442. If it has, it updates the “location” index in the database via step 1444 and continues to the next step 1446. If the location in the offer has not changed it continues to the next step 1446. The exchange updates the offer using the item ID in the database via step 1446. The exchange restarts the offer time and loads the byte counter with data transfer quantity via step 1448.

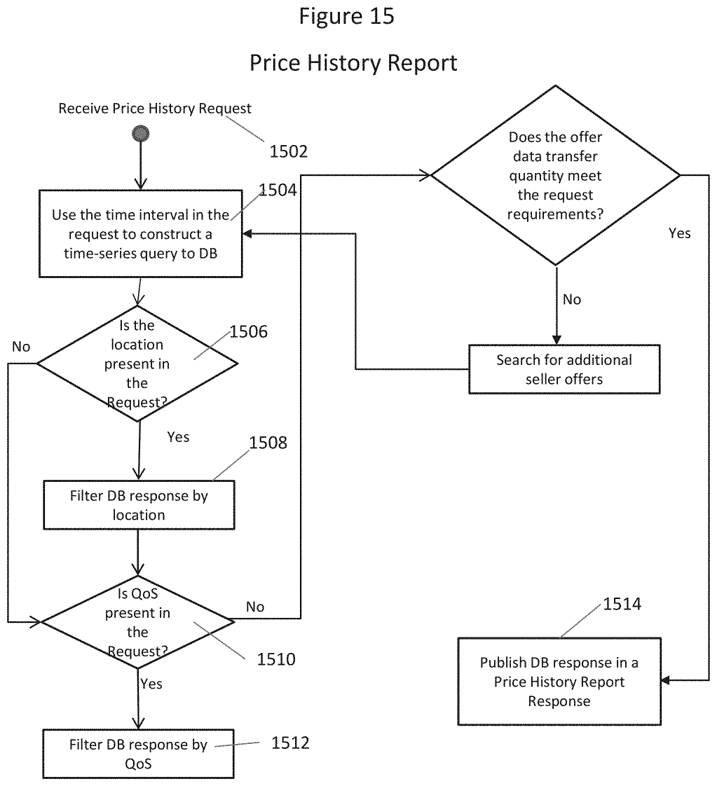

FIG. 15 illustrates the creation of price history report at the request of either the seller or the buyer, according to one or more embodiments of the invention. It may be desirable for a seller or a buyer to know historical data related to price based on parameters such as quantity, duration, location and quality of service before initiating either a data transfer offer or a data transfer discovery request. A seller may also desire to request such history before initiating a request for change. FIG. 15 illustrates the creation of price history report at the request of either the seller or the buyer. The method and system enable a buyer or seller to come up with a price associated with the service to be purchased or sold. As the exchange receives a price history request via step 1502; it uses the time interval in the request to construct a time-series query to the database via step 1504. It may check if the location is present in the request via step 1506, if the location is present; it filters the database response by location via step 1508. It may also check if the QoS is present in the request via step 1510, if the QoS is present; it filters the database response by QoS via step 1412. As shown in the figure, steps 1506 and 1510 are carried out independent of each other. The exchange then publishes the database response as a price history report via step 1514. An example of algorithm used to create a price history report is shown below.

History Report Algorithm:
(5) Calculate the nearest hours to the StartingTime_{request} and EndingTime_{request}.
(6) Construct an interval in the range: [StartingHour_{request}, EndingHour_{request}]
(7) For each hour in the range, construct a tuple in the following format:
   Hour, Item ID, Purchase Price, Location (if present), QoS (if present)
(8) Send the list of tuples in the History Report Response.

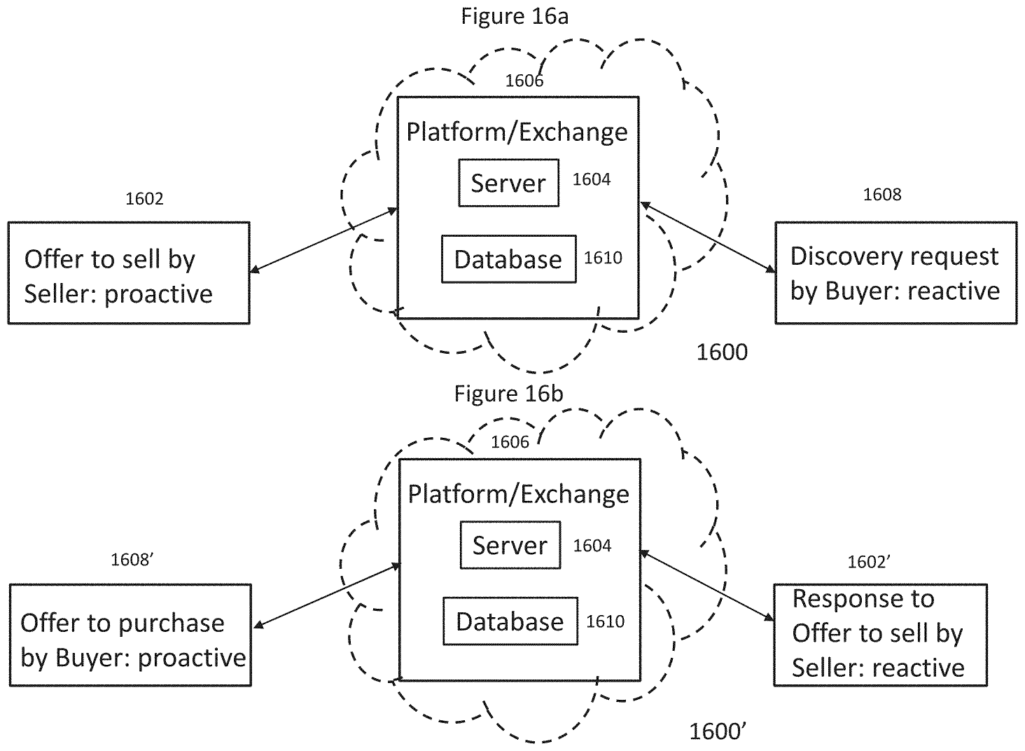

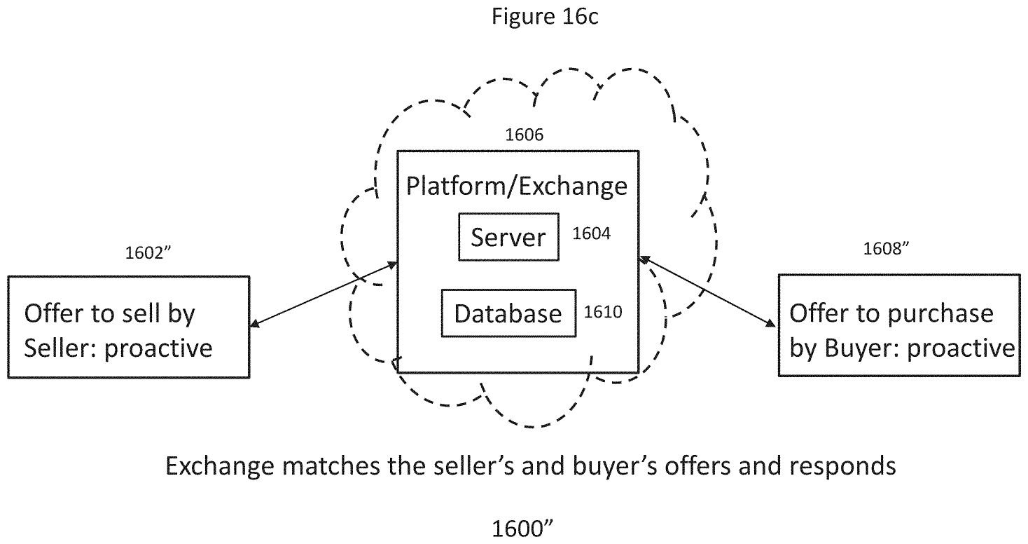

FIGS. 16a, 16b and 16c illustrate system overview 1600, 1600′ and 1600″ showing offers initiated by seller, buyer and both buyer and seller, respectively according to one or more embodiments of the invention. For example, in any of the embodiments described throughout the specification, a buyer 1608 and/or a seller 1602 may be proactive or reactive, for example, the buyer 1608 or the seller 1602 may initiate a request for services as illustrated in FIG. 16b or an offer to provide services as illustrated in FIG. 16a. In another example, a buyer and a seller may both proactively initiate a request for services and an offer to provide services as illustrated in FIG. 16c, and the exchange 1606 may match the offers and the process of sale and purchase of the service to transfer data as well as actual data transfer may continue as described throughout the specification.

Further, a buyer 1608 and/or a seller 1602 may be defined as an entity including a human or a computerized system. Similarly, the exchange 1606 may be defined as a computerized platform to carry out the steps described throughout the specification and include at least one storage database and at least one server including a processor and a memory.

The platform or exchange 1606 described throughout the specification may be located at a physical location or may be located in cloud.

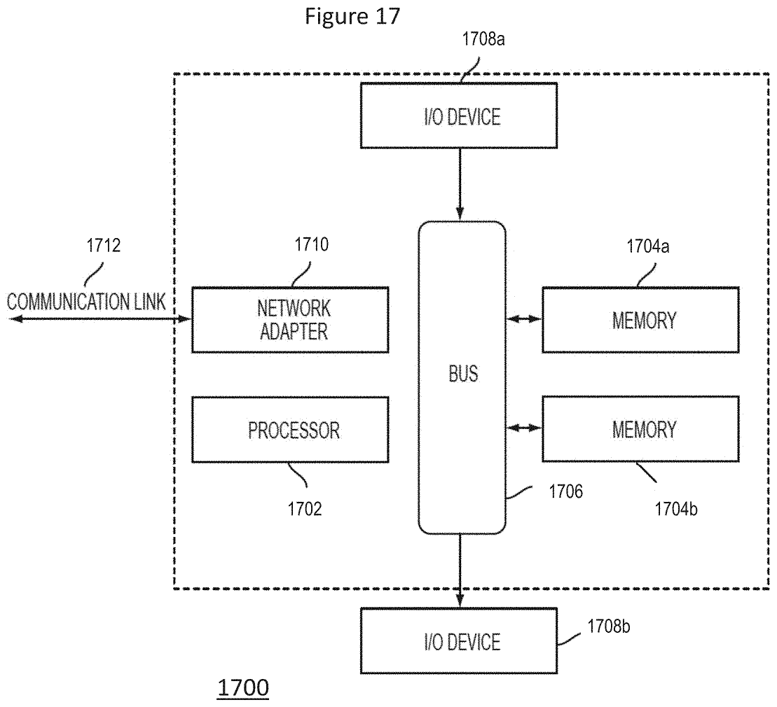

FIG. 17 illustrates a data processing system 1700 suitable for storing the computer program product and/or executing program code in accordance with an embodiment of the present invention. The data processing system 1700 includes a processor 1702 coupled to memory elements 1704a-b through a system bus 1706. In other embodiments, the data processing system 1700 may include more than one processor and each processor may be coupled directly or indirectly to one or more memory elements through a system bus.

Memory elements 1704a-b can include local memory employed during actual execution of the program code, bulk storage, and cache memories that provide temporary storage of at least some program code in order to reduce the number of times the code must be retrieved from bulk storage during execution. As shown, input/output or I/O devices 1708a-b (including, but not limited to, keyboards, displays, pointing devices, etc.) are coupled to the data processing system 1700. I/O devices 1708a-b may be coupled to the data processing system 1700 directly or indirectly through intervening I/O controllers (not shown).

In FIG. 17, a network adapter 1710 is coupled to the data processing system 1702 to enable data processing system 1702 to become coupled to other data processing systems or remote printers or storage devices through communication link 1712. Communication link 1712 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present disclosure in more detail refer now to the following description in conjunction with the accompanying Figures.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

Similarly, it is envisioned by the present invention that the term communications network includes communications across a network (such as that of a M2M but not limited thereto) using one or more communication architectures, methods, and networks, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, 5G LTE, wireless local area network (WIFI), and one or more wired networks.

### CONCLUSION

A system and method in accordance with the present invention utilizes an exchange market operated by cellular service providers or other authorized party. The system and method allow subscribers who have excess plan voice minutes, messages and bytes of data etc. to sell such excess to the subscribers who need them without either the seller or buyer having to change their service contracts, thereby preventing loss of resources both by users who spend money for unused capacity and by users who must pay for overage at high rates. Payment settlement between the seller and buyer can be performed via a mechanism chosen and implemented by the exchange.

A system and method in accordance with the present invention further utilizes an exchange market operated by cellular service providers or other authorized party. The system and method allow subscribers who have excess bytes of data to sell such excess as data transfer service to the subscribers who need them without either the seller or buyer having to change their service contracts, thereby preventing loss of resources both by users who spend money for unused capacity and by users who must pay for overage at high rates. Payment settlement between the seller and buyer can be performed via a mechanism chosen and implemented by the exchange.

A system method and computer program product in accordance with the present invention further utilizes an exchange market operated by cellular service providers or other authorized party. The system and method allow subscribers who have excess data transfer capacity to sell services to transfer data to the subscribers who need them without either the seller or buyer having to change their service contracts, thereby preventing loss of resources both by users who spend money for unused capacity and by users who must pay for overage at high rates. Payment settlement between the seller and buyer can be performed via a mechanism chosen and implemented by the exchange.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. Many other embodiments of the present invention are also envisioned.

What is claimed is:

1. A computer-implemented method for buying and selling service for transferring a quantity of data using cellular network, comprising:
receiving and storing one or more offers for transferring a quantity of data using cellular service;
receiving and processing one or more discovery requests for transferring a quantity of data using cellular service;
matching at least one of the one or more discovery requests with at least one of the one or more stored offers; and
facilitating buying and selling of the service to transfer a quantity of data.

2. The computer-implemented method of claim 1, wherein the one or more offers for transferring a quantity of data using cellular service comprise an offer to sell the service of transferring a quantity of data using cellular service initiated by a seller or an offer to buy the service of transferring a quantity of data using cellular service initiated by a buyer.

3. The computer-implemented method of claim 1, wherein the one or more offers for transferring a quantity of data using cellular service further comprises duration of time when the offer is available.

4. The computer-implemented method of claim 1, further comprising:
storing an effective quantity of data to be transferred and duration of time when the offer is available with the service profile identifiers of the one or more sellers and the one or more buyers;
deducting the purchased quantity of data to be transferred with each successful transaction from the offer to transfer a quantity of data using cellular service; and
removing the offer when the quantity of data offered for transfer reaches zero or when the duration of time when the offer is available expires.

5. The computer-implemented method of claim 1, further comprising:
deducting the purchased quantity of data to be transferred from the matched offer to transfer a quantity of data,
storing the modified offer to transfer a quantity of data for further matching, and
taking the stored offer off of the market once all quantities in the offer to transfer a quantity of data have been matched with at least one of the one or more discovery requests.

6. The computer-implemented method of claim 1, further comprising:
deducting the purchased quantity of data to be transferred from the matched offer to transfer a quantity of data,
storing the modified offer to transfer a quantity of data for further matching, and
taking the stored offer off of the market once the period during which the offer is valid has expired.

7. The computer-implemented method of claim 1, further comprising:
canceling the at least one offer to transfer a quantity of data as requested by the at least one seller,
replacing content of the at least one offer to transfer a quantity of data with content of a new offer from the request,
storing the new offer to transfer a quantity of data for further matching, and
taking the stored new offer to transfer a quantity of data off of the market once the offer has been matched with at least one of the one or more discovery requests.

8. The computer-implemented method of claim 7, wherein the content of the offer to transfer a quantity of data comprises any of: amount of data to be transferred, price for the transfer of data, duration of time within which the service to transfer a quantity of data is to be performed, location of service where the transfer a quantity of data is to be performed and quality of service.

9. The computer-implemented method of claim 1, wherein the one or more buyers is a network service provider and the at least one seller is a second network service provider.

10. The computer-implemented method of claim 1, wherein the one or more buyers is an enterprise and the at least one seller is a second enterprise.

11. A system for buying and selling service for transferring a quantity of data using cellular network, including at least one server comprising a processor, and a memory in communication with the processor wherein the memory including program instructions which when executed by the processor, perform the following operations comprising:
receiving and storing one or more offers to transfer a quantity of data using cellular service;
receiving and processing one or more discovery requests to transfer a quantity of data using cellular service;
matching at least one of the one or more discovery requests with at least one of the one or more stored offers; and
facilitating buying and selling of the service to transfer a quantity of data.

12. The system of claim 11, wherein the one or more offers for transferring a quantity of data using cellular service comprise an offer to sell the service of transferring a quantity of data using cellular service initiated by a seller or an offer to buy the service of transferring a quantity of data using cellular service initiated by a buyer.

13. The system of claim 11, wherein the one or more offers for transferring a quantity of data using cellular service initiated by the at least one seller further comprises duration of time when the offer is available.

14. The system of claim 11, wherein the operations further comprise:
storing an effective quantity of data to be transferred and duration of time when the offer is available with the service profile identifiers of the one or more sellers and the one or more buyers;
deducting the purchased quantity of data to be transferred with each successful transaction from the offer to transfer a quantity of data using cellular service; and
removing the offer when the quantity of data offered for transfer reaches zero or when the duration of time when the offer is available expires.

15. The system of claim 11, wherein the operations further comprise:
deducting the purchased quantity of data to be transferred from the matched offer to transfer a quantity of data;
storing the modified offer to transfer a quantity of data for further matching; and
taking the stored offer off of the market once all quantities in the offer to transfer a quantity of data have been matched with at least one of the one or more discovery requests.

16. The system of claim 11, wherein the operations further comprise:
deducting the purchased quantity of data to be transferred from the matched offer to transfer a quantity of data;
storing the modified offer to transfer a quantity of data for further matching; and
taking the stored offer off of the market once the period during which the offer is valid has expired.

17. The system of claim 11, wherein the operations further comprise:
canceling the at least one offer to transfer a quantity of data as requested by the at least one seller;
replacing content of the at least one offer to transfer a quantity of data with content of a new offer from the request;
storing the new offer to transfer a quantity of data for further matching; and
taking the stored new offer to transfer a quantity of data off of the market once the offer has been matched with at least one of the one or more discovery requests.

18. The system of claim 17, wherein the content of the offer to transfer a quantity of data comprises any of: amount of data to be transferred, price for the transfer of data, duration of time within which the service to transfer a quantity of data is to be performed, location of service where the transfer a quantity of data is to be performed and quality of service.

19. The system of claim 11, wherein the one or more buyers is a network service provider and the at least one seller is a second network service provider.

20. The system of claim 11, wherein the one or more buyers is an enterprise and the at least one seller is a second enterprise.

21. A computer program product stored on a non-transitory computer readable medium for buying and selling service for transferring a quantity of data using cellular network, comprising computer readable programming for causing a computer to control an execution of an application for buying and selling service for transferring a quantity of data using cellular network, comprising the steps of:
receiving and storing one or more offers to transfer a quantity of data using cellular service;
receiving and processing one or more discovery requests to transfer a quantity of data using cellular service;
matching at least one of the one or more discovery requests with at least one of the one or more stored offers; and
facilitating buying and selling of the service to transfer a quantity of data.

22. The computer program product of claim 21, wherein the one or more offers for transferring a quantity of data using cellular service comprise an offer to sell the service of transferring a quantity of data using cellular service initiated by a seller or an offer to buy the service of transferring a quantity of data using cellular service initiated by a buyer.

23. The computer program product of claim 21, wherein the one or more offers for transferring a quantity of data using cellular service initiated by the at least one seller further comprises duration of time when the offer is available.

24. The computer program product of claim 21, further comprising the step of:
storing an effective quantity of data to be transferred and duration of time when the offer is available with the service profile identifiers of the one or more sellers and the one or more buyers;
deducting the purchased quantity of data to be transferred with each successful transaction from the offer to transfer a quantity of data using cellular service; and
removing the offer when the quantity of data offered for transfer reaches zero or when the duration of time when the offer is available expires.

25. The computer program product of claim 21, further comprising the step of:
deducting the purchased quantity of data to be transferred from the matched offer to transfer a quantity of data,
storing the modified offer to transfer a quantity of data for further matching, and
taking the stored offer off of the market once all quantities in the offer to transfer a quantity of data have been matched with at least one of the one or more discovery requests.

26. The computer program product of claim 21, further comprising the step of:
deducting the purchased quantity of data to be transferred from the matched offer to transfer a quantity of data,
storing the modified offer to transfer a quantity of data for further matching, and
taking the stored offer off of the market once the period during which the offer is valid has expired.

27. The computer program product of claim 21, further comprising the step of:
canceling the at least one offer to transfer a quantity of data as requested by the at least one seller,
replacing content of the at least one offer to transfer a quantity of data with content of a new offer from the request,
storing the new offer to transfer a quantity of data for further matching, and
taking the stored new offer to transfer a quantity of data off of the market once the offer has been matched with at least one of the one or more discovery requests.

28. The computer program product of claim 27, wherein the content of the offer to transfer a quantity of data comprises any of: amount of data to be transferred, price for the transfer of data, duration of time within which the service to transfer a quantity of data is to be performed, location of service where the transfer a quantity of data is to be performed and quality of service.

29. The computer program product of claim 21, wherein the one or more buyers is a network service provider and the at least one seller is a second network service provider.

30. The computer program product of claim 21, wherein the one or more buyers is an enterprise and the at least one seller is a second enterprise.
